(19) United States
(12) Patent Application Publication
(10) Pub. No.: US 2024/0259588 A1
(43) Pub. Date: Aug. 1, 2024

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Lei Zhao, Beijing (CN); Kai Zhang, Los Angeles, CA (US); Li Zhang, Los Angeles, CA (US)

(21) Appl. No.: 18/633,268

(22) Filed: Apr. 11, 2024

Related U.S. Application Data
(63) Continuation of application No. PCT/CN2022/124204, filed on Oct. 9, 2022.

(30) Foreign Application Priority Data
Oct. 11, 2021 (WO) PCT/CN2021/123102

(51) Int. Cl. H04N 19/52; H04N 19/105; H04N 19/176

(52) U.S. Cl. CPC H04N 19/52; H04N 19/176; H04N 19/105

(57) ABSTRACT

Embodiments of the present disclosure provide a solution for video processing. A method for video processing is proposed. The method comprises: determining, during a conversion between a target video block of a video and a bitstream of the video, at least one group of motion vector predictions (MVP) candidates of the target video block; determining an MVP candidate list by sorting the at least one group of MVP candidates based on respective template matching costs of MVP candidates in the at least one group; and performing the conversion based on the MVP candidate list. In this way, a proper MVP candidate list can be determined, and thus the coding effectiveness and coding efficiency can be improved.

### CROSS REFERENCE TO RELATED APPLICATIONS

This application is a continuation of International Application No. PCT/CN2022/124204, filed on Oct. 9, 2022, which claims the benefit of International Application No. PCT/CN2021/123102 filed on Oct. 11, 2021. The entire contents of these applications are hereby incorporated by reference in their entireties.

### FIELD

Embodiments of the present disclosure relates generally to video coding techniques, and more particularly, to template matching costs-based motion vector prediction (MVP) improvement.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: determining, during a conversion between a target video block of a video and a bitstream of the video, at least one group of motion vector predictions (MVP) candidates of the target video block; determining an MVP candidate list by sorting the at least one group of MVP candidates based on respective template matching costs of MVP candidates in the at least one group; and performing the conversion based on the MVP candidate list.

The method in accordance with the first aspect of the present disclosure determines an MVP candidate list by sorting the at least one group of MVP candidates based on respective template matching costs. Compared with the conventional solution where the MVP candidates are constructed without being sorted based on the template matching costs, the MVP candidate list based on sorting can be more appropriate, and thus the coding effectiveness and coding efficiency can be improved.

In a second aspect, another method for video processing is proposed. The method comprises: determining, during a conversion between a target video block of a video and a bitstream of the video, respective template matching costs of a plurality of block vector candidates of the target video block; determining a block vector candidate list based on the respective template matching costs; and performing the conversion based on the block vector candidate list.

The method in accordance with the second aspect of the present disclosure determines a block vector candidate list based on respective template matching costs. Compared with the conventional solution where the block vector candidates are constructed without being sorted based on the template matching costs, the block vector candidate list based on sorting can be more appropriate, and thus the coding effectiveness and coding efficiency can be improved.

In a third aspect, another method for video processing is proposed. The method comprises: determining, during a conversion between a target video block of a video and a bitstream of the video, a difference between a first motion vector prediction (MVP) candidate in at least one group of MVP candidates of the target video block and a second MVP candidate of the target video block; updating the at least one group based on a comparison between the difference and a threshold; and performing the conversion at least in part based on the updated at least one group.

The method in accordance with the third aspect of the present disclosure updates the group of MVP candidates based on a difference between the MVP candidates. Compared with the conventional solution, the updated group of MVP candidates can be more appropriate, and thus the coding effectiveness and coding efficiency can be improved.

In a fourth aspect, another method for video processing is proposed. The method comprises: determining, during a conversion between a target video block of a video and a bitstream of the video, respective template matching costs of a plurality of motion vector prediction (MVP) candidates of the target video block; determining an MVP candidate list by sorting the plurality of MVP candidates based on the respective template matching costs; performing an adaptive reordering merge candidates (ARMC) process on the MVP candidate list; and performing the conversion based on the performing of the ARMC process.

The method in accordance with the fourth aspect of the present disclosure performs an ARMC process on the MVP candidate list. Compared with the conventional solution, performing the ARMC process on the MVP candidate list can improve the MVP candidate list, and thus the coding effectiveness and coding efficiency can be improved.

In a fifth aspect, another method for video processing is proposed. The method comprises: determining, during a conversion between a target video block of a video and a bitstream of the video, information regarding sorting of a plurality of motion vector prediction (MVP) candidates of the target video block based on a coding tool of the target video block; and performing the conversion based on the information.

The method in accordance with the fifth aspect of the present disclosure determines information regarding the sorting of the MVP candidates. Compared with the conventional solution, the MVP candidate list can be improved, and thus the coding effectiveness and coding efficiency can be improved.

In a sixth aspect, an apparatus for processing video data is proposed. The apparatus for processing video data comprises a processor and a non-transitory memory with instructions thereon, wherein the instructions upon execution by the processor, cause the processor to perform a method in accordance with the first, second, third, fourth or fifth aspect of the present disclosure.

In a seventh aspect, a non-transitory computer-readable storage medium is proposed. The non-transitory computer-readable storage medium stores instructions that cause a processor to perform a method in accordance with the first, second, third, fourth or fifth aspect of the present disclosure.

In an eighth aspect, a non-transitory computer-readable recording medium is proposed. The non-transitory computer-readable recording medium stores a bitstream of a video which is generated by a method performed by a video processing apparatus, wherein the method comprises: determining at least one group of motion vector predictions (MVP) candidates of a target video block of the video; determining an MVP candidate list by sorting the at least one group of MVP candidates based on respective template matching costs of MVP candidates in the at least one group; and generating the bitstream based on the MVP candidate list.

In a ninth aspect, a method for storing a bitstream of a video is proposed. The method comprises: determining at least one group of motion vector predictions (MVP) candidates of a target video block of the video; determining an MVP candidate list by sorting the at least one group of MVP candidates based on respective template matching costs of MVP candidates in the at least one group; generating the bitstream based on the MVP candidate list; and storing the bitstream in a non-transitory computer-readable recording medium.

In a tenth aspect, another non-transitory computer-readable recording medium is proposed. The non-transitory computer-readable recording medium stores a bitstream of a video which is generated by a method performed by a video processing apparatus, wherein the method comprises: determining respective template matching costs of a plurality of block vector candidates of a target video block of the video; determining a block vector candidate list based on the respective template matching costs; and generating the bitstream based on the block vector candidate list.

In an eleventh aspect, another method for storing a bitstream of a video is proposed. The method comprises: determining respective template matching costs of a plurality of block vector candidates of a target video block of the video; determining a block vector candidate list based on the respective template matching costs; generating the bitstream based on the block vector candidate list; and storing the bitstream in a non-transitory computer-readable recording medium.

In a twelfth aspect, another non-transitory computer-readable recording medium is proposed. The non-transitory computer-readable recording medium storing a bitstream of a video which is generated by a method performed by a video processing apparatus, wherein the method comprises: determining a difference between a first motion vector prediction (MVP) candidate in at least one group of MVP candidates of a target video block of the video and a second MVP candidate of the target video block; updating the at least one group based on a comparison between the difference and a threshold; and generating the bitstream at least in part based on the updated at least one group.

In a thirteenth aspect, another method for storing a bitstream of a video is proposed. The method comprises: determining a difference between a first motion vector prediction (MVP) candidate in at least one group of MVP candidates of a target video block of the video and a second MVP candidate of the target video block; updating the at least one group based on a comparison between the difference and a threshold; generating the bitstream at least in part based on the updated at least one group; and storing the bitstream in a non-transitory computer-readable recording medium.

In a fourteenth aspect, another non-transitory computer-readable recording medium is proposed. The non-transitory computer-readable recording medium storing a bitstream of a video which is generated by a method performed by a video processing apparatus, wherein the method comprises: determining respective template matching costs of a plurality of motion vector prediction (MVP) candidates of a target video block of the video; determining an MVP candidate list by sorting the plurality of MVP candidates based on the respective template matching costs; performing an adaptive reordering merge candidates (ARMC) process on the MVP candidate list; and generating the bitstream based on the performing of the ARMC process.

In a fifteenth aspect, another method for storing a bitstream of a video is proposed. The method comprises: determining respective template matching costs of a plurality of motion vector prediction (MVP) candidates of a target video block of the video; determining an MVP candidate list by sorting the plurality of MVP candidates based on the respective template matching costs; performing an adaptive reordering merge candidates (ARMC) process on the MVP candidate list; generating the bitstream based on the performing of the ARMC process; and storing the bitstream in a non-transitory computer-readable recording medium.

In a sixteenth aspect, another non-transitory computer-readable recording medium is proposed. The non-transitory computer-readable recording medium stores a bitstream of a video which is generated by a method performed by a video processing apparatus, wherein the method comprises: determining information regarding sorting of a plurality of motion vector prediction (MVP) candidates of a target video block of the video based on a coding tool of the target video block; and generating the bitstream based on the information.

In a seventeenth aspect, another method for storing a bitstream of a video is proposed. The method comprises: determining information regarding sorting of a plurality of motion vector prediction (MVP) candidates of a target video block of the video based on a coding tool of the target video block; generating the bitstream based on the information; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example diagram showing positions of spatial and temporal neighboring blocks used in AMVP/merge candidate list construction;

FIG. 5 illustrates an example diagram showing positions of non-adjacent candidate in ECM;

FIG. 6 illustrates an example diagram showing an example of the positions for non-adjacent TMVP candidates;

FIG. 7 illustrates an example diagram showing an example of the template;

FIG. 8 illustrates an example diagram showing a reference template specified by a MV;

FIG. 9 illustrates an example diagram showing a reference template specified by the MV associated with an MVP candidate;

FIG. 10 illustrates an example diagram showing an example of the template matching cost ordering based MVP list construction;

FIG. 11 illustrates an example diagram showing an example of the template matching derivation and sorting process;

FIG. 12 illustrates an example diagram showing an example of MVP list construction for merge mode;

FIG. 13 illustrates an example diagram showing another example of MVP list construction for merge mode;

FIG. 14 illustrates an example diagram showing an example of MVP list construction for AMVP mode;

FIG. 15 illustrates an example diagram showing another example of MVP list construction for AMVP mode;

FIG. 16 illustrates an example diagram showing examples of non-adjacent positions;

FIG. 17 illustrates a flowchart of a method for video processing in accordance with some embodiments of the present disclosure;

FIG. 18 illustrates another flowchart of a method for video processing in accordance with some embodiments of the present disclosure;

FIG. 19 illustrates another flowchart of a method for video processing in accordance with some embodiments of the present disclosure;

FIG. 20 illustrates another flowchart of a method for video processing in accordance with some embodiments of the present disclosure;

FIG. 21 illustrates another flowchart of a method for video processing in accordance with some embodiments of the present disclosure; and

FIG. 22 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

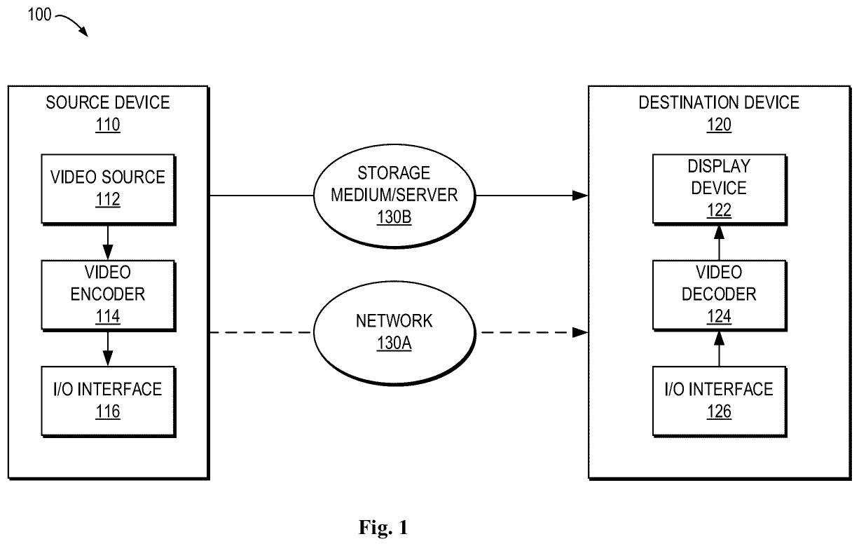

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

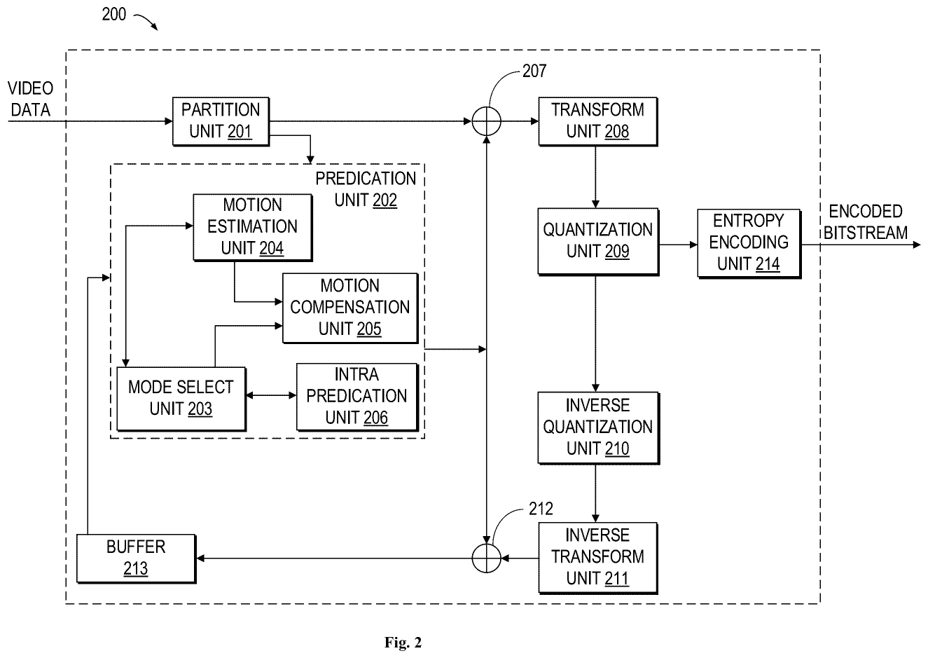

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

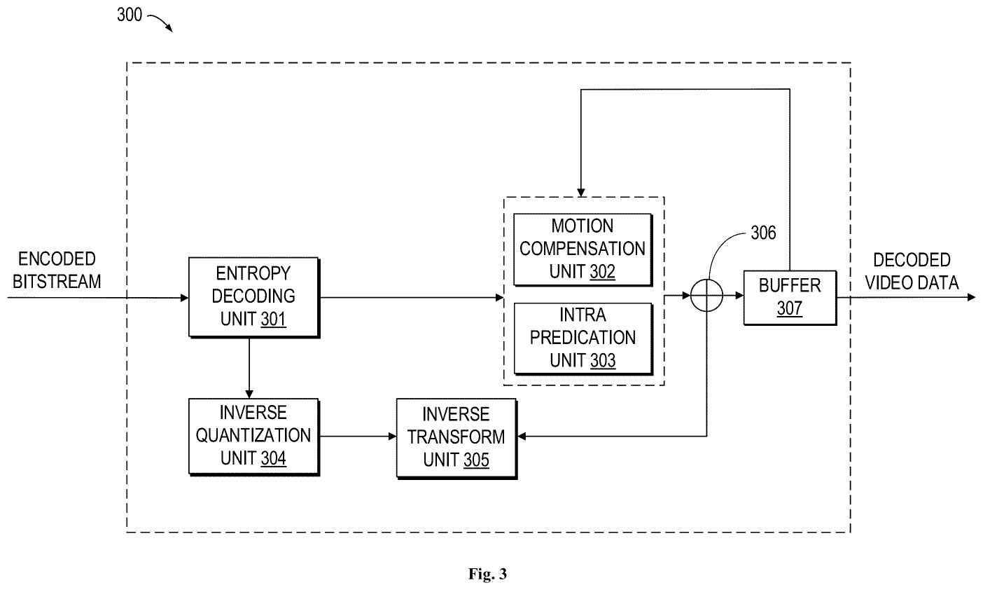

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. SUMMARY

This disclosure is related to video coding technologies. Specifically, it is about motion vector prediction (MVP) construction method in video coding. The ideas may be applied individually or in various combination, to any video coding standard or non-standard video codec.

### 2. BACKGROUND

The exponential increasing of multimedia data poses a critical challenge for video coding. To satisfy the increasing demands for more efficient compression technology, ITU-T and ISO/IEC have developed a series of video coding standards in the past decades. In particular, the ITU-T produced H.261 and H.263, ISO/IEC produced MPEG-1 and MPEG-4 visual, and the two organizations jointly developed the H.262/MPEG-2 Video, H.264/MPEG-4 Advanced Video Coding (AVC), H.265/HEVC and the latest VVC standards. Since H.262/MPEG-2, hybrid video coding framework is employed wherein in intra/inter prediction plus transform coding are utilized.

Inter prediction aims to remove the temporal redundancy between adjacent frames, which serves as an indispensable component in the hybrid video coding framework. Specifically, inter prediction makes use of the contents specified by motion vector (MV) as the predicted version of the current to-be-coded block, thus only residual signals and motion information are transmitted in the bitstream. To reduce the cost for MV signaling, motion vector prediction (MVP) came into being as an effective mechanism to convey motion information. Early strategies simply use the MV of a specified neighboring block or the median MV of neighboring blocks as MVP. In H.265/HEVC, competing mechanism was involved where the optimal MVP is selected from multiple candidates through rate distortion optimization (RDO). In particular, advanced MVP (AMVP) mode and merge mode are devised with different motion information signaling strategy. With the AMVP mode, a reference index, an MVP candidate index referring to an AMVP candidate list and motion vector difference (MVD) is signaled. Regarding the merge mode, only a merge index referring to a merge candidate list is signaled, and all the motion information associated with the merge candidate is inherited. Both AMVP mode and merge mode need to construct MVP candidate list, and the details of the construction process for these two modes are described as follows.

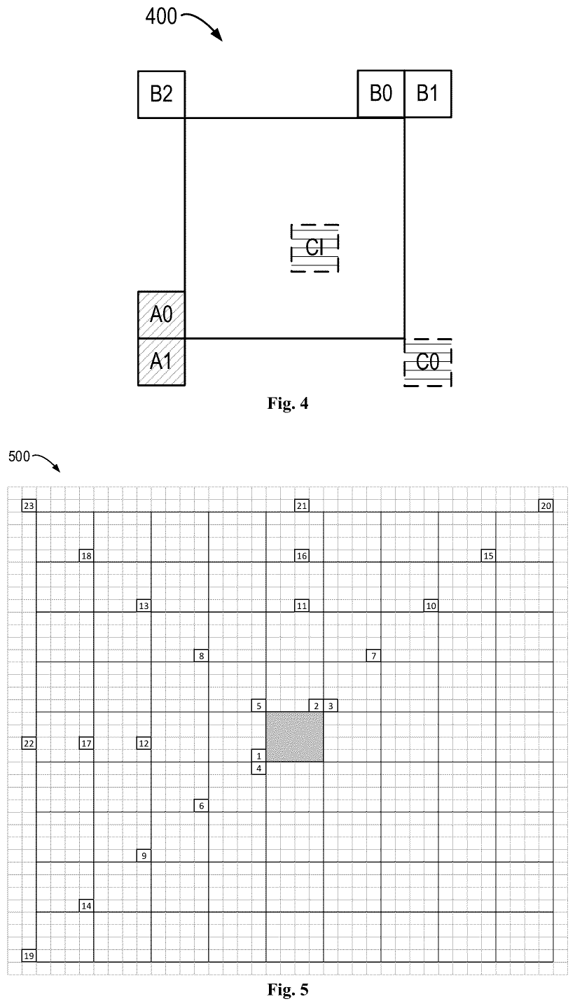

AMVP mode: AMVP exploits spatial-temporal correlation of motion vector with neighboring blocks, which is used for explicit transmission of motion parameters. For each reference picture list, a motion vector candidate list is constructed by firstly checking availability of left, above temporally neighboring positions, removing redundant candidates and adding zero vector to make the candidate list to be constant length. FIG. 4 illustrates an example diagram 400 showing positions of spatial and temporal neighboring blocks used in AMVP/merge candidate list construction. For spatial motion vector candidate derivation, two motion vector candidates are eventually derived based on motion vectors of blocks located in five different positions as depicted in FIG. 4. The five neighboring blocks located at B0, B1, B2, and A0, A1 are classified into two groups, where Group A includes the three above spatial neighboring blocks and Group B includes the two left spatial neighboring blocks. The two MV candidates are respectively derived with the first available candidate from Group A and Group B in a predefined order. For temporal motion vector candidate derivation, one motion vector candidate is derived based on two different co-located positions (bottom-right (C0) and central (C1)) checked in order, as depicted in FIG. 4. To avoid redundant MV candidates, duplicated motion vector candidates in the list are abandoned. If the number of potential candidates is smaller than two, additional zero motion vector candidates are added to the list.

Merge mode: Similar to AMVP mode, MVP candidate list for merge mode comprises of spatial and temporal candidates as well. For spatial motion vector candidate derivation, at most four candidates are selected with order A1, B1, B0, A0 and B2 after performing availability and redundant checking. For temporal merge candidate (TMVP) derivation, at most one candidate is selected from two temporal neighboring blocks (C0 and C1). When there are not enough merge candidates with spatial and temporal candidates, combined bi-predictive merge candidates and zero MV candidates are added to MVP candidate list. Once the number of available merge candidates reaches the signaled maximally allowed number, the merge candidate list construction process is terminated.

In VVC, the construction process for merge mode is further improved by introducing the history-based MVP (HMVP), which incorporates the motion information of previously coded blocks which may be far away from current block. In VVC, HMVP merge candidates are appended to merge list after the spatial MVP and TMVP. In this method, the motion information of a previously coded block is stored in a table and used as MVP for the current CU. The table with multiple HMVP candidates is maintained with first-in-first-out strategy during the encoding/decoding process. Whenever there is a non-subblock inter-coded CU, the associated motion information is added to the last entry of the table as a new HMVP candidate.

During the standardization of VVC, Non-adjacent MVP was proposed to facilitate better motion information derivation by exploiting the non-adjacent area. FIG. 5 illustrates an example diagram 500 showing positions of non-adjacent candidate in ECM. In ECM software, Non-adjacent MVP are inserted between TMVP and HMVP, where the distances between non-adjacent spatial candidates and current coding block are based on the width and height of current coding block as depicted in FIG. 5.

### 3. PROBLEMS

(1) Existing MVP list construction methods target at building a subset with constant MVP number from a given candidate set, which is normally realized by selecting the available candidates in a predefined order. This strategy, however, does not exploit the prior information produced during encoding/decoding process, which may lead to the mismatch between the true motion information and that of the candidates in the constructed MVP list.
(2) The current non-adjacent MVP only considers the spatial positions that locate in the same frame as the current block, whereas the non-adjacent temporal positions may also provide valuable motion information that are absent within the spatial MVP candidates.
(3) Existing pruning process for MVP candidate only regards identical MVs as redundancy. Consequently, the constructed MVP list may contain quite similar MVs such that the diversity within the list is limited.

### 4. DETAILED DESCRIPTIONS

In this disclosure, an optimized MVP list derivation method based on template matching cost ordering is proposed. Instead of constructing the MVP list based on a predefined traversing order, an optimized MVP selecting approach is investigated by taking advantage of the matching cost in the reconstructed template region, such that more appropriate candidates are included in the list.

It should be noted that the proposed strategy for MVP list construction can be utilized in normal merge and AMVP list construction process and can also be easily extended to other modules that require MVP derivation, e.g., merge with motion vector difference (MMVD), Affine motion compensation, Subblock-based temporal motion vector prediction (SbTMVP) and so on.

The detailed embodiments below should be considered as examples to explain general concepts. These embodiments should not be interpreted in a narrow way. Furthermore, these embodiments can be combined in any manner. Combination between this disclosure and other disclosures are also applicable.

### Non-Adjacent TMVP

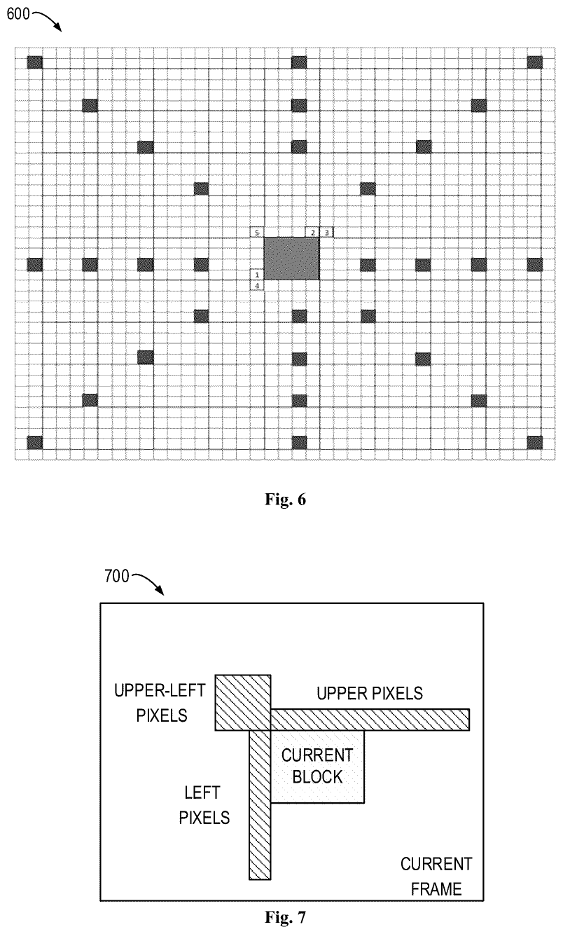

1. It is proposed to make use of the TMVP in a non-adjacent area to further improve the effectiveness of the MVP list.
   a) In one example, a non-adjacent area may be any block (such as 4×4 block) in a reference picture and neither inside nor adjacent to the collocated block in the reference picture of the current block.
   b) FIG. 6 illustrates an example diagram 600 showing an example of the positions for non-adjacent TMVP candidates. In one example, the positions of the non-adjacent TMVP candidates are illustrated in FIG. 6, where black blocks represent the potential non-adjacent TMVP positions. It should be noted that this figure only provides an example for non-adjacent TMVP, and the positions are not limited to the indicated blocks. In other cases, non-adjacent TMVP may locate in any other positions in one or more reconstructed frames.
2. The maximum allowed non-adjacent TMVP number in the MVP list may be signaled in the bitstream.
   a) In one example, the maximum allowed number can be signaled in SPS or PPS.
3. The non-adjacent TMVP candidates may locate in the nearest reconstructed frame, but it may also locate in other reconstructed frames.
   a) Alternatively, non-adjacent TMVP candidates may locate in the collocated picture.
   b) Alternatively, it is signaled in which picture non-adjacent TMVP candidates may locate.
4. Non-adjacent TMVP candidates may locate in multiple reference pictures.
5. The distances between a non-adjacent area associated with a TMVP candidate and current coding block may be related to the property of the current block.
   a) In one example, the distances depend on the width and height of current coding block.
   b) In other cases, the distances may be signaled in the bitstream as a constant.

### Definition of the Template

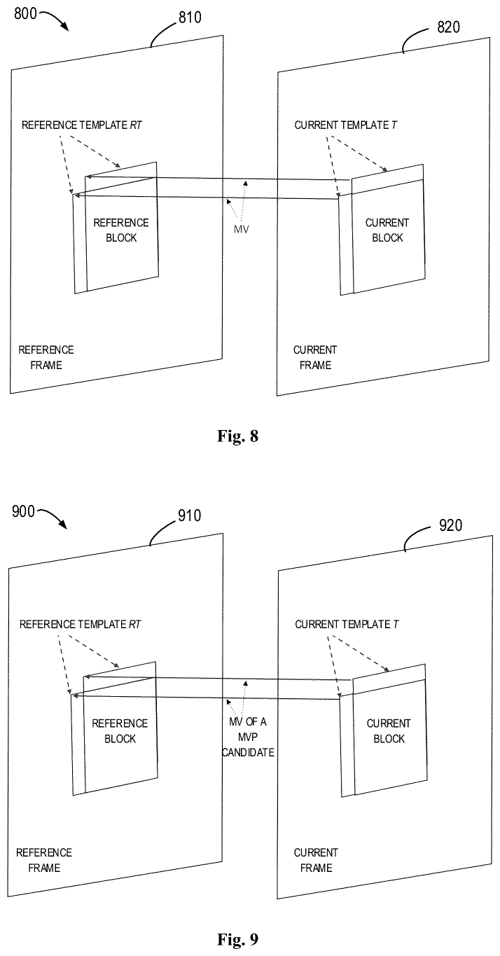

6. Template represents the reconstructed region that can be used to estimate the priority of a MVP candidate, which may locate in different positions with variable shape.
   a) FIG. 7 illustrates an example diagram 700 illustrating an example of the template. In one example, a template may comprise of the reconstructed regions in three positions, which are upper pixels, left pixels and upper-left pixels, as presented in FIG. 7.
   b) It should be noted that the template may not necessarily be in rectangular shape, it can be in arbitrary shape, e.g., triangle or polygon.
   c) In one example, the template regions may be utilized either in separate or combined manner.
   d) A template may only comprise samples from one component such as luma, or from multiple components such as luma and chroma.
7. The template may not necessarily locate in the current frame, it may locate in any other reconstructed frame.
8. In one example, a reference template region with the same shape as the template of the current block may be located with a MV, as shown in FIG. 8, which illustrates an example diagram 800 showing a reference template of a reference frame 810 specified by a MV of a current template of a current frame 820.
9. In one example, the template may not necessarily locate in adjacent area, it may locate in non-adjacent areas that are far away from the current block.
10. In one example, a template may not necessarily contain all the pixels in a certain region, it may contain part of the pixels in a region.

### Template Matching Based MVP Candidate Ordering

11. In this invent, template matching cost associated with a certain MVP candidate serves as a measurement to evaluate the consistency of this candidate and true motion information. Based on this measurement, a more efficient order is generated by sorting the priority of each MVP candidate.
   a) FIG. 9 illustrates and example diagram 900 showing a reference template of a reference frame 910 specified by the MV associated with an MVP candidate of a current template of a current frame 920. In one example, the template matching cost C is evaluated with mean of square error (MSE), as calculated below:

$$C = \frac{{\sum }_{( i , j ) ∈ T} {( T ( i , j ) - R T ( i , j ) )}^{2}}{N} ,$$

where T represents the template region, RT represents the corresponding reference template region specified by the MV within MVP candidate (as shown in FIG. 9), N is the pixel number within the template.
b) In one example, the template matching cost can be evaluated with sum of square error (SSE), sum of absolute difference (SAD), sum of absolute transformed difference (SATD) or any other criterion that can measure the difference between two regions.
12. All the MVP candidates are sorted in an ascending order regarding the corresponding template matching cost, and the MVP list is constructed by traversing the candidates in the sorted order until the MVP amount reaches the maximum allowed number. In this way, a candidate with a lower matching cost has a higher priority to be included in the ultimate MVP list.
   a) In one example, the sorting process may be conducted towards all the MVP candidates.
   b) Alternatively, this process may also be applied to part of candidates, e.g., non-adjacent MVP candidates, HMVP candidates or any other group of candidates.
   c) Alternatively, furthermore, which categories of MVP candidates (e.g., non-adjacent MVP candidates are belonging to one category, HMVP candidates are belonging to another category) and/or what kinds of group of candidates should be reordered may be dependent on the decoded information, e.g., block dimension/coding methods (e.g., CIIP/MMVD) and/or how many available MVP candidates before being reordered for a given kind/group.
      1. In one example, the sorting process may be conducted for a joint group which contains only one category of MVP candidates.
      2. In one example, the sorting process may be conducted for a joint group which contains more than one category of MVP candidates.
         a) In one example, for a first coding method (e.g., regular/CIIP/MMVD/GPM/TPM/subblock merge mode), the sorting process can be conducted for a joint group of non-adjacent MVP, non-adjacent TMVP and HMVP candidates. For a second coding method (e.g., the template matching merge mode), the sorting process can be conducted for a joint group of adjacent MVP, non-adjacent TMVP, non-adjacent MVP and HMVP candidates.
         b) Alternatively, for a first coding method (e.g., regular/CIIP/MMVD/GPM/TPM/subblock merge mode), the sorting process can be conducted for a joint group of non-adjacent MVP and HMVP candidates. For a second coding method (e.g., the template matching merge mode), the sorting process can be conducted for a joint group of adjacent MVP, non-adjacent MVP and HMVP candidates.
      3. In one example, the sorting process may be conducted for a joint group which contains partial of available MVP candidates within the categories.
         a) In one example, for regular/CIIP/MMVD/TM/GPM/TPM/subblock merge mode, or for regular/affine AMVP mode, the sorting process can be conducted for a joint group of all or partial candidates from one or multiple categories.
      4. In above examples, the category may be
         i. adjacent neighboring MVPs;
         ii. adjacent neighboring MVPs at specific location(s);
         iii. TMVP MVPs;
         iv. HMVP MVPs;
         V. Non-adjacent MVPs;
         vi. Constructed MVPs (such as pairwise MVPs);
         vii. Inherited affine MV candidates;
         viii. Constructed affine MV candidates;
         ix. SbTMVP candidates.
   d) In one example, this process may be conducted multiple times on different set of candidates.
      1. For example, a set of candidates (such as non-adjacent MVP candidates) may be sorted, and the N non-adjacent MVP candidates with the lowest costs may be put into the candidate list. After the whole candidate list is constructed, the costs of candidates in the list may be calculated and the candidates may be reordered based on the costs.
13. It is proposed that the MVP list construction process may involve both reordering of a single group/category and a joint group which contains candidates from more than one category.
   a) In one example, the joint group may include candidates from a first and a second category.
      1. Alternatively, furthermore, the first and second category may be defined as the non-adjacent MVP category and HMVP category.
      2. Alternatively, furthermore, the first and second category may be defined as the non-adjacent MVP category and HMVP category, and the joint group may include candidates from a third category, e.g., TMVP category.
   b) In one example, the single group may include candidates from a fourth category.
      1. Alternatively, furthermore, the fourth category may be defined as the adjacent MVP category.
14. Multiple groups or categories can be respectively reordered to construct MVP list.
   a) In one example, only one single group (all the candidates belong to one category, e.g. adjacent MVP, non-adjacent MVP, HMVP, etc.) is built and reordered in MVP list construction process.
   b) In one example, only one joint group (contains partial or all the candidates from multiple categories) is built and reordered in MVP list construction process.
   c) In one example, more than one group (regardless of single or joint) are respectively built and reordered in MVP list construction process.
      1. In one example, two or more single groups are respectively built and reordered in MVP list construction process.
      2. In one example, two or more joint groups are respectively built and reordered in MVP list construction process.
      3. In one example, one or multiple single groups and one or multiple joint groups are respectively reordered in MVP list construction process.
         a) In one example, one single groups and one joint groups are respectively built and reordered to construct MVP list.
         b) In one example, one single groups and multiple joint groups are respectively built and reordered to construct MVP list.
         c) In one example, multiple single groups and one joint groups are respectively built and reordered to construct MVP list.
         d) In one example, multiple single groups and multiple joint groups are respectively built and reordered to construct MVP list.
   d) In one example, candidates that belong to the same category can be divided into different groups, and are respectively reordered in the corresponding groups.
   e) In one example, only partial candidates in specific category are put into the single or joint group, and rest candidates in this category are not reordered.
   f) In above examples, the category may be:
      1. adjacent neighboring MVPs;
      2. adjacent neighboring MVPs at specific location(s);
      3. TMVP MVPs;
      4. HMVP MVPs;
      5. Non-adjacent MVPs;
      6. Constructed MVPs (such as pairwise MVPs);
      7. Inherited affine MV candidates;
      8. Constructed affine MV candidates;
      9. SbTMVP candidates.
15. The proposed sorting method can also be applied to AMVP mode.
   a) In one example, the MVP in AMVP mode can be extended with non-adjacent MVP, non-adjacent TMVP and HMVP.
   b) In one example, MVP list for AMVP mode comprises K candidates, which are selected from M categories, such as adjacent MVPs, non-adjacent MVPs, non-adjacent TMVPs and HMVPs wherein K and M are integers.
      1. In one example, K could be smaller than M, or equal to M or greater than M.
      2. In one example, one candidate is selected from each category.
      3. Alternatively, for a given category, no candidate is selected.
      4. Alternatively, for a given category, more than 1 candidate is selected.
      5. In one example, MVP list for AMVP mode comprises 4 candidates, which are selected from adjacent MVPs, non-adjacent MVPs, non-adjacent TMVPs and HMVPs.
      6. In one example, each category of MVP candidates is respectively sorted with template matching cost, and the one with minimum cost in the corresponding type is selected and included in the MVP list.
      7. Alternatively, adjacent MVP candidates and a joint group of non-adjacent MVP, non-adjacent TMVP together with HMVP candidates are respectively sorted with template matching cost. One adjacent candidate with the minimum template matching cost is selected from adjacent MVP candidates, and three other candidates are derived by traversing the candidates in the joint group in an ascending order of template matching cost.
      8. In one example, MVP list for AMVP mode comprises 2 candidates, one comes from adjacent MVP and the other comes from non-adjacent MVP, non-adjacent TMVP or HMVP. In particular, adjacent MVP candidates and a joint group of non-adjacent MVP, non-adjacent TMVP together with HMVP are respectively sorted with template matching cost, and the one with minimum cost in the corresponding type (or group) is included in the MVP list.
16. The proposed sorting methods may be applied to other coding methods, e.g., for constructing a block vector list of IBC coded blocks.
   a) In one example, it may be used for affine coded blocks.
   b) Alternatively, furthermore, how to define the template cost may be dependent on the coding methods.
17. The usage of this method may be controlled with different coding level syntax, including but not limit to one or multiple of PU, CU, CTU, slice, picture, sequence levels.
18. On how to insert sorted candidates to MVP list.
   a) In one example, which candidates within the joint or separate group are included into MVP list depends on the sorting results of template matching cost.
   b) In one example, whether put the candidates within the separate or joint group into MVP list depends on the sorting results of template matching cost.
   c) In one example, how many candidates within the separate or joint group are included into MVP list depends on the sorting results of template matching cost.
      1. In one example, only one candidate with the smallest template matching cost is included into MVP list.
      2. In one group, top-N candidates regarding the template matching cost in an ascending order are included into MVP list, where N is the maximum allowed candidate number can be inserted into MVP list in the corresponding single or joint group.
         a) In one example, N can be a predefined constant for each single or joint group.
         b) Alternatively, N can be adaptively derived based on the template matching cost within the single or joint group.
         c) Alternatively, N can be signaled in the bitstream.
         d) In one example, different candidate groups share a same N value.
         e) Alternatively, different single or joint groups may have different N value.

### Pruning for MVP Candidates

19. The pruning for MVP candidates aims to increase the diversity within the MVP list, which can be realized by using appropriate threshold TH.
   a) In one example, if the two candidates point to same reference frame, they may both be included to MVP list only if the absolute difference between the corresponding X and Y components are either or both larger (or no smaller) than TH.
20. The pruning threshold can be signaled in the bitstream.
   b) In one example, the pruning threshold can be signaled either in PU, CU, CTU or slice level.
21. The pruning threshold may depend on the characteristics of the current block.
   c) In one example, the threshold may be derived by analyzing the diversity among the candidates.
   d) In one example, the optimal threshold can be derived through RDO.
22. The pruning for MVP candidates may be firstly performed within a single or joint group before being sorted.
   a) Alternatively, furthermore, for two MVP candidates belonging to two different groups or one belonging to a joint group and the other doesn't, pruning among these two MVP candidates are not performed before sorting.
   b) Alternatively, furthermore, pruning among multiple groups may be applied after the sorting.
23. The pruning for MVP candidates may be firstly performed among multiple groups and the sorting may be further applied to one or multiple single/joint groups.
   a) Alternatively, an MVP list may be firstly constructed with pruning among available MVP candidates involved. Afterwards, sorting may be further applied to reorder one or multiple single/joint groups.
   b) Alternatively, furthermore, for two MVP candidates belonging to two different groups or one belonging to a joint group and the other doesn't, pruning among these two MVP candidates is performed before sorting.
      Interaction with Other Coding Tools
24. After an MVP list with above sorting methods applied, the Adaptive Reordering Merge Candidates (ARMC) process may be further applied.
   a) In one example, the template costs used in the sorting process during MVP list construction may be further utilized in the ARMC.
   b) In another example, different template costs may be used in the sorting process and ARMC process.
      1. In one example, the template may be different for the sorting and ARMC process.
25. Whether to and/how to enable the sorting process may be dependent on the coding tool.
   a) In one example, when a certain tool (e.g., MMVD or affine mode) is enabled for a block, the sorting is disabled.
   b) In one example, for two different tools, the sorting rules may be different (e.g., being applied to different groups or different template settings).

### 5. EMBODIMENTS

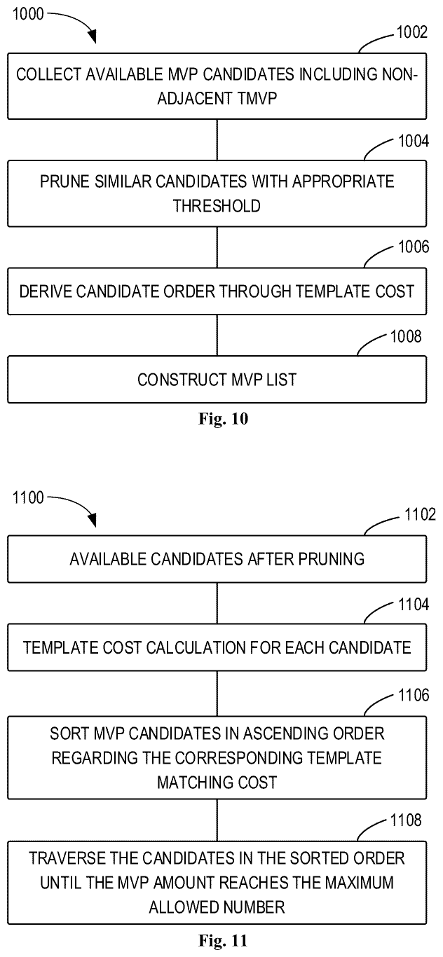

FIG. 10 illustrates an example diagram 1000 showing an example of the template matching cost ordering based MVP list construction. An example of the coding flow for the template matching cost ordering based MVP list construction is presented in FIG. 10. At block 1002, available MVP candidates including non-adjacent TMVP are collected. At block 1004, similar candidates are pruned with appropriate threshold. At block 1006, candidate order is derived through template cost. At block 1008, MVP list is constructed.

FIG. 11 illustrates an example diagram 1100 showing an example of the template matching derivation and sorting process. At block 1102, available candidates after pruning are obtained. At block 1104, template cost is calculated for each candidate. At block 1106, MVP candidates are sorted in ascending order regarding the corresponding template matching cost. At block 1108, the candidates in the sorted order are traversed until the MVP amount reaches the maximum allowed number.

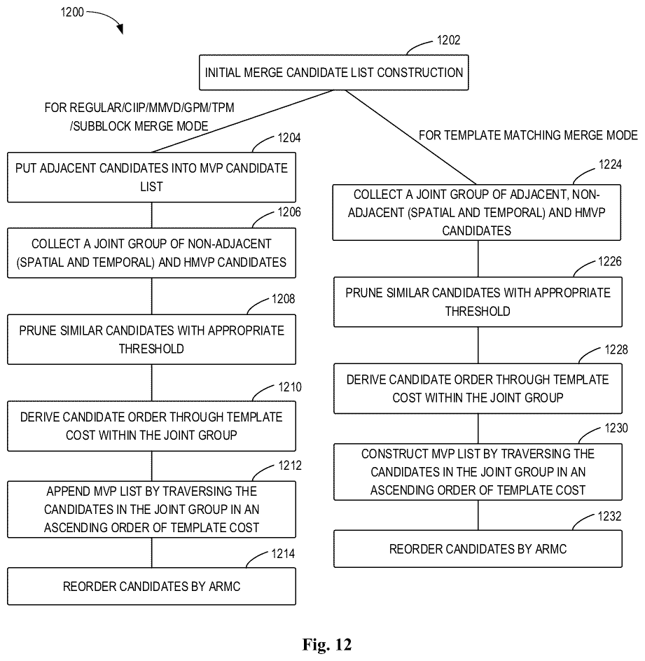

FIG. 12 illustrates an example diagram 1200 showing an example of MVP list construction for merge mode. FIG. 12 provides an example of the proposed MVP list construction for merge mode. When encoder/decoder starts to build a MVP candidate list for merge mode at block 1202, different methods are used for different merge modes. In particular, if the current mode is regular/CIIP/MMVD/GPM/TPM/subblock merge mode, adjacent candidates are firstly put into MVP candidate list at block 1204. Then a joint group which contains one or more than one category of MVP candidates (e.g. non-adjacent and HMVP candidates as in FIG. 12, note that a joint group can also comprises different partial or combination of candidates) is built at block 1206, and pruning operation with appropriate threshold is conducted within the joint group at block 1208. Subsequently, template matching cost associated with each candidates within the join group is calculated as described in bullet 11 at block 1210. After that, encoder/decoder will append MVP list by traversing the candidates in the joint group in an ascending order of template matching cost until all the candidates in the joint group are traversed or MVP list reaches maximum allowed number at block 1212. If all the candidates within the joint group are traversed and MVP list still has vacant positions, remaining candidates which are not belong to the joint group will be included in the MVP list in a predefined order until the list reaches maximum allowed candidate number. After MVP list is constructed, it can be further reordered with ARMC at block 1214.

If current merge mode is template matching merge mode, a joint group which contains different category of MVP candidates (e.g. adjacent, non-adjacent and HMVP candidates as in FIG. 12, note that a joint group can also comprises different partial or combination of candidates) is firstly built at block 1224, then pruning process and template matching cost derivation are conducted at block 1226 and block 1228 in the same way as regular/CIIP/MMVD/GPM/TPM/subblock merge mode. Then, encoder/decoder will construct MVP list by traversing the candidates in the joint group in an ascending order of template matching cost until all the candidates in the joint group are traversed or MVP list reaches maximum allowed number at block 1230. If all the candidates within the joint group are traversed and MVP list still has vacant positions, remaining candidates which are not belong to the joint group will be included in the MVP list in a predefined order until the list reaches maximum allowed candidate number. After MVP list is constructed, it can be further reordered with ARMC at block 1232.

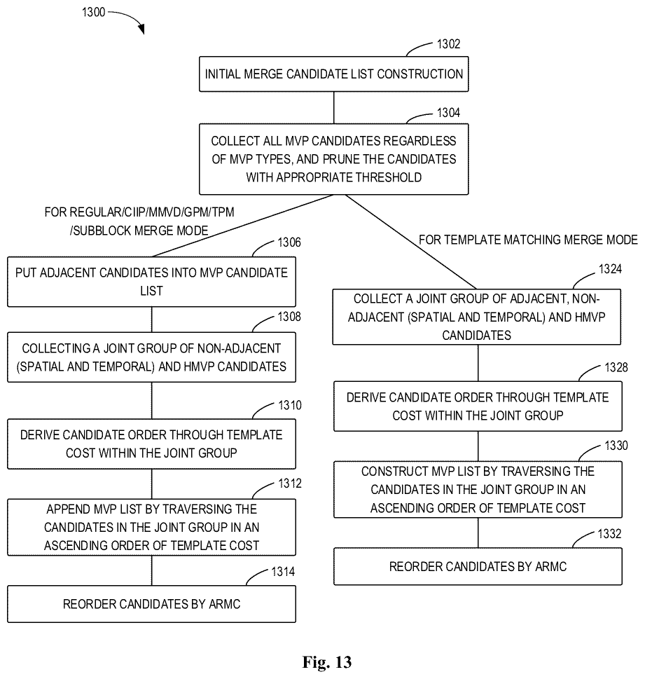

FIG. 13 illustrates an example diagram 1300 showing another example of MVP list construction for merge mode. The difference between the method in FIG. 12 and FIG. 13 is that, in FIG. 13, when encoder/decoder starts to build a MVP candidate list at block 1302, it will firstly collect all the candidates regardless of MVP types, and the pruning operation is conducted for all the candidates at block 1304. Whereas for the example in FIG. 12, the pruning is conducted for partial of candidates (or a joint group).

Similar to FIG. 12, for regular/CIIP/MMVD/GPM/TPM/subblock merge mode, at block 1306, adjacent candidates are put into MVP candidate list. At block 1308, a joint group of non-adjacent (spatial and temporal) and HMVP candidates are collected. At block 1310, a candidate order is derived through template cost within the joint group. At block 1312, MVP list is appended by traversing the candidates in the joint group in an ascending order of template cost. At block 1314, the candidates are reordered by ARMC. For template matching merge mode, at block 1324, a joint group of adjacent, non-adjacent (spatial and temporal) and HMVP candidates are collected. At block 1328, a candidate order is derived through template cost within the joint group. At block 1330, an MVP list is constructed by traversing the candidates in the joint group in an ascending order of template cost. At block 1332, the candidates are reordered by ARMC.

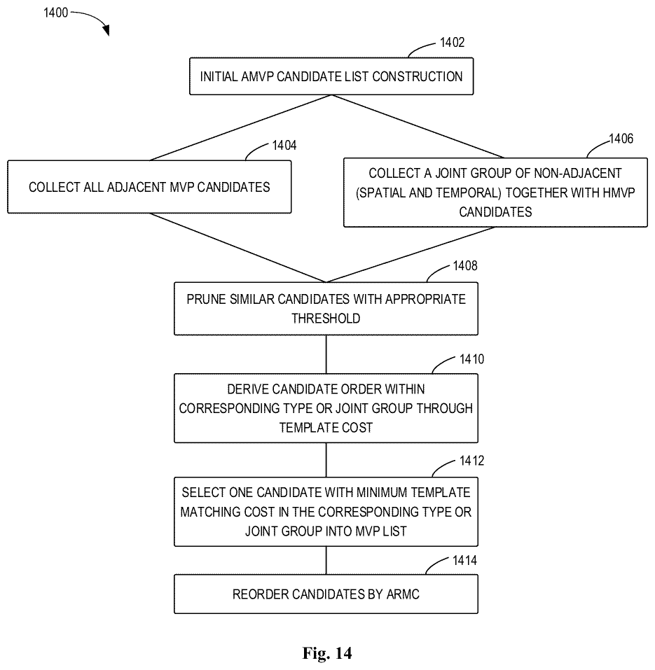

FIG. 14 illustrates an example diagram 1400 showing an example of MVP list construction for AMVP mode. When encoder/decoder starts to build a MVP candidate list for AMVP mode at block 1402, two joint groups are respectively built. One joint group comprises all the adjacent candidates at block 1404 and the other joint group contains partial or all of the remaining candidates (e.g., non-adjacent spatial and temporal MVP together with HMVP at block 1406 as shown in FIG. 14, note that a joint group can also comprises different partial or combination of candidates), and pruning operation with appropriate threshold is conducted within the joint group at block 1408. Subsequently, template matching cost associated with each candidate within the join group is calculated as described in bullet 11 at block 1410. After that, encoder/decoder will select one candidate with minimum template matching cost in the corresponding type or joint group into MVP list at block 1412. After MVP list is constructed, it can be further reordered with ARMC at block 1414.

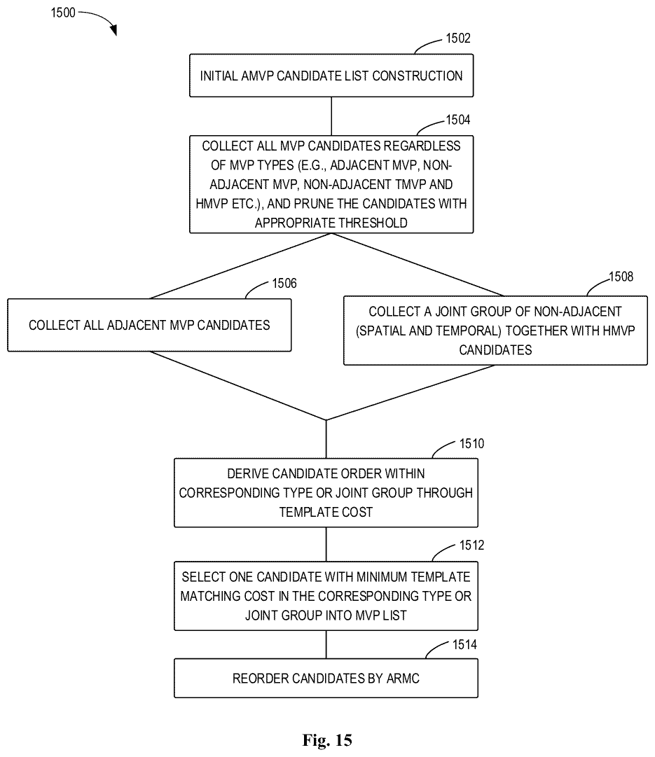

FIG. 15 illustrates an example diagram 1500 showing another example of MVP list construction for AMVP mode. The difference between the method in FIG. 14 and FIG. 15 is that, in FIG. 15, when encoder/decoder starts to build a MVP candidate list at block 1502, it will firstly collect all the candidates regardless of MVP types at block 1504, and the pruning operation is conducted for all the candidates at block 1504. Whereas for the example in FIG. 14, the pruning is conducted for partial of candidates (or a joint group).

Similar to FIG. 14, at block 1506, all adjacent MVP candidates are collected at block 1506. A joint group of non-adjacent (spatial and temporal) together with HMVP candidates are collected. At block 1510, a candidate order is derived within corresponding type or joint group through template cost. At block 1512, one candidate with minimum template cost in the corresponding type or joint group may be selected into MVP list. At block 1514, the candidates are reordered by ARMC.

In another example, when encoder/decoder starts to build an MVP candidate list, a single group and a joint group are respectively built and reordered. In particular, the single group comprises all or partial of the TMVP candidates including adjacent TMVPs, non-adjacent TMVPs and the constructed TMVPs using temporal neighboring positions. Whereas the joint group comprises all or partial of the candidates of non-adjacent MVPs and HMVPs. If the current is mode regular/CIIP/MMVD/GPM/TPM/subblock merge mode, adjacent spatial candidates are firstly put into MVP candidate list. Then, pruning operation with appropriate threshold is conducted within each group. Subsequently, template matching cost associated with each candidate within the corresponding group is calculated as described in bullet 11. After that, encoder/decoder will put K (K is an integer than 0) candidates in the single group into MVP list in an ascending order of template matching cost. Then encoder/decoder will append MVP list by traversing the candidates in the joint group in an ascending order of template matching cost until all the candidates in the joint group are traversed or MVP list reaches maximum allowed number. If all the candidates within the joint group are traversed and MVP list still has vacant positions, remaining candidates which are not belong to the joint group will be included in the MVP list in a predefined order. It should be noted that encoder/decoder can also firstly collect all the candidates regardless of MVP types, and the pruning operation is conducted for all the candidates. Also, the single group and joint group in this example can comprise any other MVP type.

In another example, when encoder/decoder starts to build a MVP candidate list, a joint group is built and reordered. In particular, when adjacent MVP satisfies some certain conditions (e.g., the number of valid adjacent MVP larger than a constant N), the template matching cost associated with each valid adjacent candidates is calculated as described in bullet 11. Then one or more adjacent candidates are put into MVP list in an ascending order of template matching cost. After that, the remaining adjacent MVP candidates, together with non-adjacent MVPs and HMVPs, constitute a joint group for reordering, and pruning operation with appropriate threshold is conducted with this joint group. Subsequently, template matching cost associated with each candidate within the group is calculated as described in bullet 11. After that, encoder/decoder will append MVP list by traversing the candidates within the joint group in an ascending order of template matching cost until all the candidates in the joint group are traversed or MVP list reaches maximum allowed number. If all the candidates within the joint group are traversed and MVP list still has vacant positions, remaining candidates which are not belong to the joint group will be included in the MVP list in a predefined order. It should be noted that encoder/decoder can also firstly collect all the candidates regardless of MVP types, and the pruning operation is conducted for all the candidates. Also, the joint group in this example can comprise any other MVP type.

In this contribution, a method of template matching based MVP candidate list construction (TM-MCLC) is proposed. Instead of putting adjacent, non-adjacent and HMVP candidates into the MVP candidate list in a predefined traversing order, TM-MCLC puts adjacent, non-adjacent (both spatial and temporal) and HMVP candidates into the MVP candidate list in an ascending order of template matching costs.

In ECM, adjacent, non-adjacent and HMVP candidates are put into the MVP candidate list based on a predefined traversing order. With TM-MCLC, non-adjacent and HMVP candidates are put into the MVP candidate list in an ascending order of template matching costs.

More specifically, for template matching merge mode, all available adjacent, non-adjacent MVP and HMVP are collected in a group after pruning operation. Then TM cost associated with each candidate in the group is derived in a similar way to ARMC. Subsequently, all the candidates in the group are sorted in an ascending order regarding the corresponding TM costs. Finally, adjacent, non-adjacent and HMVP candidates are put into the merge candidate list an ascending order of template matching costs. For other merge mode (e.g. regular/CIIP/MMVD/GPM/TPM/subblock merge mode. etc.), TM-MCLC conducts similar operations as in template matching merge mode except the candidate group comprises only non-adjacent and HMVP candidates.

For AMVP mode, MVP list comprises 2 candidates, one comes from adjacent MVP and the other comes from non-adjacent MVP or HMVP. In particular, adjacent MVP candidates and a joint group of non-adjacent MVP together with HMVP are respectively sorted (after pruning operation) with template matching cost, and the one with minimum cost in the corresponding type (or group) is included in the MVP list.

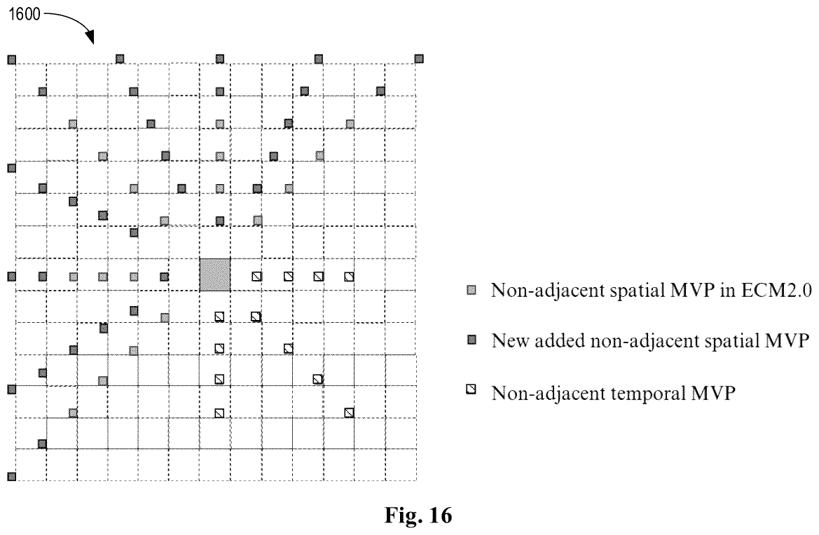

FIG. 16 illustrates an example diagram 1600 showing examples of non-adjacent positions. In this proposal, non-adjacent MVPs in ECM software is further extended with more spatial and non-adjacent temporal positions, as shown in FIG. 16. Besides the 18 positions for non-adjacent spatial MVPs in ECM-2.0, additional 32 spatial positions and 12 non-adjacent temporal positions are introduced, where non-adjacent temporal MVP positions locate in the same reference frame as the adjacent TMVP. An example of the coding flow for the template matching cost ordering based MVP list construction is presented in FIG. 10, FIGS. 12-15. Regarding the bullet 11 and 12 in section 4, an example is provided in FIG. 11.

The embodiments of the present disclosure are related to motion vector prediction (MVP) construction and enhancement. As used herein, the term “block” may represent a coding tree block (CTB), a coding tree unit (CTU), a coding block (CB), a coding unit (CU), a prediction unit (PU), a transform unit (TU), a prediction block (PB), a transform block (TB), or a video processing unit comprising a plurality of samples or pixels. A block may be rectangular or non-rectangular.

It is to be understood that the present method for MVP or MVP list construction can be utilized in normal merge and AMVP list construction process and can also be easily extended to other modules that requires MVP derivation, such as merge with motion vector difference (MMVD), Affine motion compensation, Subblock-based temporal motion vector prediction (SbTMVP) and so on.

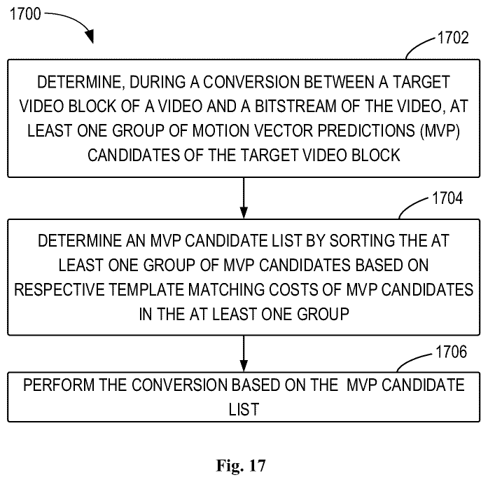

FIG. 17 illustrates a flowchart of a method 1700 for video processing in accordance with some embodiments of the present disclosure. The method 1700 may be implemented during a conversion between a target video block of a video and a bitstream of the video. As shown in FIG. 17, at block 1702, at least one group of motion vector predictions (MVP) candidates of the target video block is determined. At block 1704, an MVP candidate list is determined by sorting the at least one group of MVP candidates based on respective template matching costs of MVP candidates in the at least one group.

In this way, an MVP candidate list can be determined by sorting at least one group of MVP candidates based on template matching costs. Instead of constructing the MVP list based on a predefined traversing order, determining the MVP candidates list by sorting the MVP candidates based on the template matching cost, more appropriate MVP candidate list can be selected for video coding. The coding effectiveness and coding efficiency can be thus improved.

At block 1706, the conversion is performed based on the MVP candidate list. In some embodiments, the conversion may include encoding the target video block into the bitstream. Alternatively, or in addition, the conversion may include decoding the target video block from the bitstream.

In some embodiments, the at least one group of MVP candidates comprises a first group of MVP candidates and a second group of MVP candidates. The first group may be associated with one candidate category. The second group may be associated with more than one category. In other words, the MVP candidate list construction process may involve both reordering of the single group and the joint group which contains candidates from more than one category.

In some embodiments, the second group comprises MVP candidates of at least first and second candidate categories. By way of example, the first candidate category comprises a non-adjacent MVP candidate category, and the second category comprises a history-based motion vector predictor (HMVP) candidate category.

In some embodiments, the first group further comprises MVP candidates of a third candidate category different from the first and second candidate categories. By way of example, the third candidate category comprises a temporal motion vector prediction (TMVP) candidate category.

In some embodiments, the first group comprises MVP candidates associated with a fourth candidate category. For example, the fourth candidate category may comprise an adjacent MVP candidate category.

In some embodiments, the at least one group of MVP candidates comprises at least one single group of MVP candidates. The single group of MVP candidates is associated with a single candidate category. By way of example, the single candidate category comprises at least one of: an adjacent MVP candidate category, a non-adjacent MVP candidate category, or a history-based motion vector predictor (HMVP) candidate category.

In some embodiments, the at least one group of MVP candidates comprises at least one joint group of MVP candidates. The joint group of MVP candidates is associated with more than one candidate category. For example, a joint group of the at least one joint group of MVP candidates may comprise at least a partial of MVP candidates associated with more than one candidate category.

In some embodiments, at block 1702, if a coding tool of the target video block comprises a first coding tool, non-adjacent MVP candidates and history-based motion vector predictor (HMVP) candidates may be added into a first joint group of MVP candidates.

By way of example, the first coding tool comprises at least one of: a regular merge mode coding tool, a combination of intra and inter predication (CIIP) merge mode coding tool, a merge mode with motion vector difference (MMVD) coding tool, a geometric partitioning mode (GPM) coding tool, a triangle partition mode (TPM) coding tool, or a subblock merge mode coding tool. It is to be understood that the examples of the first coding tool are only for the purpose of illustration, without suggesting any limitation.

In some embodiments, at block 1702, if a coding tool of the target video block comprises a second coding tool, adjacent MVP candidates, non-adjacent MVP candidates and history-based motion vector predictor (HMVP) candidates may be added into a second joint group of MVP candidates. For example, the second coding tool may comprise a template matching merge mode coding tool. It is to be understood that the examples of the second coding tool are only for the purpose of illustration, without suggesting any limitation.

In some embodiments, the at least one group of MVP candidates comprises at least one single group of MVP candidates and at least one joint group of MVP candidates. The single group may be associated with one candidate category. The joint group may be associated with more than one candidate category.

In some embodiments, at block 1702, a plurality of MVP candidates of a same candidate category may be divided into a plurality of groups. In other words, candidates that belong to the same category may be divided into different groups, and respectively reordered to construct MVP candidate list.

In some embodiments, for a group of the plurality of groups, MVP candidates in the group may be sorted based on respective template matching costs of the MVP candidates. For example, multiple single groups and/or multiple joint groups are respectively built and reordered to construct MVP candidate list.

In some embodiments, at block 1702, a partial of MVP candidates of a fifth candidate category may be added into a group of candidates. The group is associated with at least one candidate category comprising the fifth candidate category. In some embodiments, the at least one group of MVP candidates may be sorted without sorting remaining candidates of the fifth candidate category. That is, partial candidates in specific category are put into the single or joint group, and rest candidates in this category are not reordered.

In some embodiments, the candidate category comprises at least one of the following: an adjacent neighboring MVP category, an adjacent neighboring MVP at a predefined location, a temporal motion vector prediction (TMVP) MVP category, a history-based motion vector predictor (HMVP) MVP category, a non-adjacent MVP category, a constructed MVP category, a pairwise MVP category, an inherited affine MV candidate category, a constructed affine MV candidate category, or a subblock-based temporal motion vector prediction (SbTMVP) candidate category. It is to be understood that the examples of the candidate category are only for the purpose of illustration, without suggesting any limitation.

In some embodiments, at block 1704, a set of MVP candidates may be determined from the at least one group of MVP candidates list based on a sorting result of the respective template matching costs. The set of MVP candidates may be added into the MVP candidate list.

In some embodiments, at block 1704, whether to add a first MVP candidate in the at least one group of MVP candidates into the MVP candidate list may be determined based on a sorting result of the respective template matching costs. The MVP candidate list may be determined based on the determination of adding the first MVP candidate.

In some embodiments, at block 1704, a number of MVP candidates in the at least one group of MVP candidates to be added into the MVP candidate list may be determined based on a sorting result of the respective template matching costs. The number of MVP candidates from the at least one group of MVP candidates may be added into the MVP candidate list.

In some embodiments, at block 1704, a second MVP candidate in the at least one group with a smallest template matching cost may be added into the MVP candidate list.

In some embodiments, at block 1704, a second number of top MVP candidates in the at least one group in an ascending order of template matching costs may be added into the MVP candidate list.

In some embodiments, the second number is a maximum allowed number of MVP candidates in the at least one group to be added into the MVP candidate list. For example, the second number may comprise a predefined constant associated with the at least one group.

In some embodiments, the second number may be determined based on template matching costs of MVP candidates in the at least one group.

In some embodiments, the second number may be included in the bitstream. That is, the second number may be signaled in the bitstream.

Alternatively, or in addition, in some embodiments, a value of the second number is associated with a first group of MVP candidates and a second group of MVP candidates. In some embodiments, a first value of the second number associated with a first group of MVP candidates is different from a second value of the second number associated with a second group of MVP candidates.

According to embodiments of the present disclosure, it is proposed that the MVP candidate list used in the video coding can be improved. In this way, the coding effectiveness and coding efficiency may be improved.

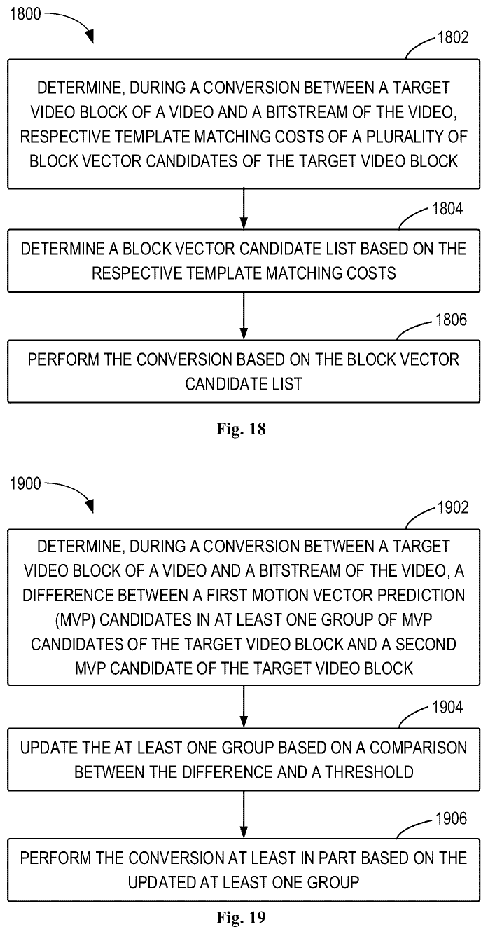

FIG. 18 illustrates a flowchart of a method 1800 for video processing in accordance with some embodiments of the present disclosure. The method 1800 may be implemented during a conversion between a target video block of a video and a bitstream of the video. As shown in FIG. 18, at block 1802, respective template matching costs of a plurality of block vector candidates of the target video block are determined. At block 1804, a block vector candidate list is determined based on the respective template matching costs.

In this way, the block vector candidate list can be determined based on template matching costs. In this way, the block vector candidate list can be improved. The coding effectiveness and coding efficiency can be thus improved.

At block 1806, the conversion is performed based on the block vector candidate list. In some embodiments, the conversion may include encoding the target video block into the bitstream. Alternatively, or in addition, the conversion may include decoding the target video block from the bitstream.

In some embodiments, the block vector candidate list comprises a block vector list of affine coded blocks. Alternatively, or in addition, in some embodiments, the block vector candidate list comprises a block vector list of intra block copy (IBC) coded blocks. It is to be understood that the examples of the block vector candidate list are only for the purpose of illustration, without suggesting any limitation.

In some embodiments, at block 1802, a template cost metric is determined based on a coding method of the target video block. The respective template matching costs may be determined by using the template cost metric.

According to embodiments of the present disclosure, it is proposed that the MVP candidates used in the video coding may be sorted and improved. In this way, the coding effectiveness and coding efficiency may be improved.

FIG. 19 illustrates a flowchart of a method 1900 for video processing in accordance with some embodiments of the present disclosure. The method 1900 may be implemented during a conversion between a target video block of a video and a bitstream of the video. As shown in FIG. 19, at block 1902, a difference between a first motion vector prediction (MVP) candidate in at least one group of MVP candidates of the target video block and a second MVP candidate of the target video block is determined. At block 1904, the at least one group is updated based on a comparison between the difference and a threshold.

In this way, the group of MVP candidates can be updated based on the differences between MVP candidates. Thus, the coding effectiveness and coding efficiency can be thus improved.

At block 1906, the conversion is performed at least in part based on the updated at least one group. In some embodiments, the conversion may include encoding the target video block into the bitstream. Alternatively, or in addition, the conversion may include decoding the target video block from the bitstream.

In some embodiments, at block 1904, if the difference is less than the threshold, at least one of the first MVP candidate or the second MVP candidate is removed from the at least one group.

In some embodiments, at block 1906, the updated at least one group is sorted based on respective matching template costs of MVP candidates in the updated at least one group. An MVP candidate list may be determined based on the sorting. The conversion may be determined based on the MVP candidate list.

In some embodiments, a third MVP candidate and a fourth MVP candidate of the target video block is sorted without comparing a further difference between the third and fourth MVP candidates and the threshold. An MVP candidate list may be determined based on the sorting. The conversion may be performed based on the MVP candidate list.

By way of example, the third MVP candidate may belong to a first group of the at least one group, and the fourth MVP candidate may belong to a second group of the at least one group. The second group is different from the first group. For another example, the third MVP candidate may belong to a first group of MVP candidates, and the fourth MVP candidate may be absent from the at least one group. In other words, for two candidates belonging to different groups or one belonging to a joint group and the other doesn't, pruning of candidates among these candidates are not performed before sorting.

In some embodiments, the at least one group of MVP candidates comprises a plurality of groups of MVP candidates sorted based on respective template matching costs of the MVP candidates.

In some embodiments, the at least one group comprises a plurality of groups of MVP candidates. At block 1906, at least one of the updated plurality of groups may be sorted based on respective matching template costs of MVP candidates in at least one of the updated plurality of groups. An MVP candidate list may be determined based on the sorting. The conversion may be performed based on the MVP candidate list.

In some embodiments, the first MVP candidate belongs to a first group of the at least one group, and the second MVP candidate belongs to a second group of the at least one group. The second group is different from the first group.

In some embodiments, the first MVP candidate belongs to a first group of MVP candidates, and the second MVP candidate is absent from the at least one group.

In some embodiments, the at least one group comprises a plurality of groups of MVP candidates. At block 1906, an MVP candidate list may be determined based on the updated at least one group. At least one group of candidates in the MVP candidate list may be sorted. The MVP candidate list may be updated based on the sorting. The conversion may be performed based on the updated MVP candidate list.

In some embodiments, the at least one group of MVP candidates comprises a single group of MVP candidates. The single group is associated with a candidate category. Alternatively, or in addition, in some embodiments, the at least one group of MVP candidates comprises a joint group of MVP candidates. The joint group is associated with more than one candidate category.

In some embodiments, the candidate category comprises at least one of the following: an adjacent neighboring MVP category, an adjacent neighboring MVP at a predefined location, a temporal motion vector prediction (TMVP) MVP category, a history-based motion vector predictor (HMVP) MVP category, a non-adjacent MVP category, a constructed MVP category, a pairwise MVP category, an inherited affine MV candidate category, a constructed affine MV candidate category, or a subblock-based temporal motion vector prediction (SbTMVP) candidate category. It is to be understood that the examples of candidate category are only for the purpose of illustration, without suggesting any limitation.

According to embodiments of the present disclosure, it is proposed that the MVP candidate group used in the video coding may be updated and improved. In this way, the coding effectiveness and coding efficiency may be improved.

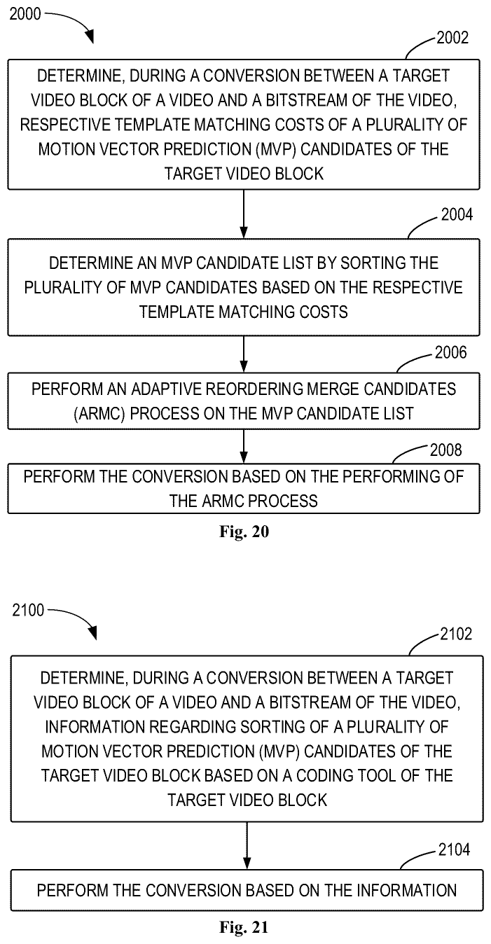

FIG. 20 illustrates a flowchart of a method 2000 for video processing in accordance with some embodiments of the present disclosure. The method 2000 may be implemented during a conversion between a target video block of a video and a bitstream of the video. As shown in FIG. 20, at block 2002, respective template matching costs of a plurality of motion vector prediction (MVP) candidates of the target video block are determined. At block 2004, an MVP candidate list is determined by sorting the plurality of MVP candidates based on the respective template matching costs. At block 2006, an adaptive reordering merge candidates (ARMC) process is performed on the MVP candidate list.

In this way, the MVP candidate list can be improved by the ARMC process, and thus the coding effectiveness and coding efficiency can be improved.

At block 2008, the conversion is performed based on the performing of the ARMC process. In some embodiments, the conversion may include encoding the target video block into the bitstream. Alternatively, or in addition, the conversion may include decoding the target video block from the bitstream.

In some embodiments, at block 2006, the ARMC process may be performed based on the respective template matching costs of MVP candidates in the MVP candidate list.

Alternatively, or in addition, in some embodiments, at block 2006, respective further template matching costs of MVP candidates are determined in the MVP candidate list. The ARMC process may be performed based on the respective further template matching costs of MVP candidates in the MVP candidate list.

In some embodiments, the respective further template matching costs may be determined based on a further template different from a template used in the determination of the respective template matching costs.

According to embodiments of the present disclosure, it is proposed that the MVP candidate list may be improved by the ARMC process. In this way, the coding effectiveness and coding efficiency may be improved.

FIG. 21 illustrates a flowchart of a method 2100 for video processing in accordance with some embodiments of the present disclosure. The method 2100 may be implemented during a conversion between a target video block of a video and a bitstream of the video. As shown in FIG. 21, at block 2102, information regarding sorting of a plurality of motion vector prediction (MVP) candidates of the target video block is determined based on a coding tool of the target video block.

In this way, the MVP candidates can be sorted based on the information. In this way, MVP candidates can be improved, and the coding effectiveness and coding efficiency can be thus improved.

At block 2104, the conversion is performed based on the information. In some embodiments, the conversion may include encoding the target video block into the bitstream. Alternatively, or in addition, the conversion may include decoding the target video block from the bitstream.

In some embodiments, the information comprises whether to enable the sorting of the plurality of MVP candidates. Alternatively, or in addition, in some embodiments, the information comprises how to enable the sorting of the plurality of MVP candidates.

In some embodiments, if the coding tool comprises a merge mode with motion vector difference (MMVD) coding tool or an affine mode coding tool, the information indicates to disable the sorting.

In some embodiments, a first sorting rule associated with a first coding tool is different from a second sorting rule associated with a second coding tool. By way of example, the first sorting rule is applied to a first group of MVP candidates, and the second sorting rule is applied to a second group of MVP candidates.

Alternatively, or in addition, in some embodiments, the first sorting rule is applied to MVP candidates with a first template setting, and the second sorting rule is applied to MVP candidates with a second template setting.

According to embodiments of the present disclosure, it is proposed that the MVP candidates can be sorted based on the determined information. In this way, the coding effectiveness and coding efficiency may be improved.

It is to be understood that the above method 1700 and/or method 1800 and/or method 1900 and/or method 2000 and/or method 2100 may be used in combination or separately. Any suitable combination of these methods may be applied. Scope of the present disclosure is not limited in this regard.

Implementations of the present disclosure can be described in view of the following clauses, the features of which can be combined in any reasonable manner.

Clause 1. A method for video processing, comprising: determining, during a conversion between a target video block of a video and a bitstream of the video, at least one group of motion vector predictions (MVP) candidates of the target video block; determining an MVP candidate list by sorting the at least one group of MVP candidates based on respective template matching costs of MVP candidates in the at least one group; and performing the conversion based on the MVP candidate list.

Clause 2. The method of clause 1, wherein the at least one group of MVP candidates comprises a first group of MVP candidates and a second group of MVP candidates, the first group being associated with one candidate category, the second group being associated with more than one category.

Clause 3. The method of clause 2, wherein the second group comprises MVP candidates of at least first and second candidate categories.

Clause 4. The method of clause 3, wherein the first candidate category comprises a non-adjacent MVP candidate category, and the second category comprises a history-based motion vector predictor (HMVP) candidate category.

Clause 5. The method of clause 3 or clause 4, wherein the first group further comprises MVP candidates of a third candidate category different from the first and second candidate categories.

Clause 6. The method of clause 5, wherein the third candidate category comprises a temporal motion vector prediction (TMVP) candidate category.

Clause 7. The method of any of clauses 2-6, wherein the first group comprises MVP candidates associated with a fourth candidate category.

Clause 8. The method of clause 7, wherein the fourth candidate category comprises an adjacent MVP candidate category.

Clause 9. The method of clause 1, wherein the at least one group of MVP candidates comprises at least one single group of MVP candidates, the single group of MVP candidates being associated with a single candidate category.

Clause 10. The method of clause 9, wherein the single candidate category comprises at least one of: an adjacent MVP candidate category, a non-adjacent MVP candidate category, or a history-based motion vector predictor (HMVP) candidate category.

Clause 11. The method of clause 1, wherein the at least one group of MVP candidates comprises at least one joint group of MVP candidates, the joint group of MVP candidates being associated with more than one candidate category.

Clause 12. The method of clause 11, wherein a joint group of the at least one joint group of MVP candidates comprises at least a partial of MVP candidates associated with more than one candidate category.

Clause 13. The method of clause 11 or clause 12, wherein determining the at least one group comprises: in accordance with a determination that a coding tool of the target video block comprises a first coding tool, adding non-adjacent MVP candidates and history-based motion vector predictor (HMVP) candidates into a first joint group of MVP candidates.

Clause 14. The method of clause 13, wherein the first coding tool comprises at least one of: a regular merge mode coding tool, a combination of intra and inter predication (CIIP) merge mode coding tool, a merge mode with motion vector difference (MMVD) coding tool, a geometric partitioning mode (GPM) coding tool, a triangle partition mode (TPM) coding tool, or a subblock merge mode coding tool.

Clause 15. The method of any of clauses 11-14, wherein determining the at least one group comprises: in accordance with a determination that a coding tool of the target video block comprises a second coding tool, adding adjacent MVP candidates, non-adjacent MVP candidates and history-based motion vector predictor (HMVP) candidates into a second joint group of MVP candidates.

Clause 16. The method of clause 15, wherein the second coding tool comprises a template matching merge mode coding tool.

Clause 17. The method of clause 1, wherein the at least one group of MVP candidates comprises at least one single group of MVP candidates and at least one joint group of MVP candidates, the single group being associated with one candidate category, and the joint group being associated with more than one candidate category.

Clause 18. The method of any of clauses 1-17, wherein determining the at least one group comprises: dividing a plurality of MVP candidates of a same candidate category into a plurality of groups.

Clause 19. The method of clause 18, wherein sorting the at least one group of MVP candidates comprises: for a group of the plurality of groups, sorting MVP candidates in the group based on respective template matching costs of the MVP candidates.

Clause 20. The method of any of clauses 1-19, wherein determining the at least one group comprises: adding a partial of MVP candidates of a fifth candidate category into a group of candidates, the group being associated with at least one candidate category comprising the fifth candidate category.

Clause 21. The method of clause 20, wherein sorting the at least one group of MVP candidates comprises: sorting the at least one group of MVP candidates without sorting remaining candidates of the fifth candidate category.

Clause 22. The method of any of clauses 11-21, wherein the candidate category comprises at least one of the following: an adjacent neighboring MVP category, an adjacent neighboring MVP at a predefined location, a temporal motion vector prediction (TMVP) MVP category, a history-based motion vector predictor (HMVP) MVP category, a non-adjacent MVP category, a constructed MVP category, a pairwise MVP category, an inherited affine MV candidate category, a constructed affine MV candidate category, or a subblock-based temporal motion vector prediction (SbTMVP) candidate category.

Clause 23. The method of any of clauses 1-22, wherein determining the MVP candidate list comprises: determining a set of MVP candidates from the at least one group of MVP candidates list based on a sorting result of the respective template matching costs; and adding the set of MVP candidates into the MVP candidate list.

Clause 24. The method of any of clauses 1-23, wherein determining the MVP candidate list comprises: determining whether to add a first MVP candidate in the at least one group of MVP candidates into the MVP candidate list based on a sorting result of the respective template matching costs; and determining the MVP candidate list based on the determination of adding the first MVP candidate.

Clause 25. The method of any of clauses 1-24, wherein determining the MVP candidate list comprises: determining a number of MVP candidates in the at least one group of MVP candidates to be added into the MVP candidate list based on a sorting result of the respective template matching costs; and adding the number of MVP candidates from the at least one group of MVP candidates into the MVP candidate list.

Clause 26. The method of any of clauses 1-25, wherein determining the MVP candidate list comprises: adding a second MVP candidate in the at least one group with a smallest template matching cost into the MVP candidate list.

Clause 27. The method of any of clauses 1-25, wherein determining the MVP candidate list comprises: adding a second number of top MVP candidates in the at least one group in an ascending order of template matching costs into the MVP candidate list.

Clause 28. The method of clause 27, wherein the second number is a maximum allowed number of MVP candidates in the at least one group to be added into the MVP candidate list.

Clause 29. The method of clause 27 or clause 28, wherein the second number comprises a predefined constant associated with the at least one group.

Clause 30. The method of clause 27 or clause 28, further comprising: determining the second number based on template matching costs of MVP candidates in the at least one group.

Clause 31. The method of any of clauses 27-30, further comprising: including the second number in the bitstream.

Clause 32. The method of any of clauses 27-31, wherein a value of the second number is associated with a first group of MVP candidates and a second group of MVP candidates.

Clause 33. The method of any of clauses 27-31, wherein a first value of the second number associated with a first group of MVP candidates is different from a second value of the second number associated with a second group of MVP candidates.

Clause 34. A method for video processing, comprising: determining, during a conversion between a target video block of a video and a bitstream of the video, respective template matching costs of a plurality of block vector candidates of the target video block; determining a block vector candidate list based on the respective template matching costs; and performing the conversion based on the block vector candidate list.

Clause 35. The method of clause 34, wherein the block vector candidate list comprises at least one of: a block vector list of affine coded blocks, or a block vector list of intra block copy (IBC) coded blocks.

Clause 36. The method of clause 34 or clause 35, wherein determining the respective template matching costs comprises: determining a template cost metric based on a coding method of the target video block; and determining the respective template matching costs by using the template cost metric.

Clause 37. A method for video processing, comprising: determining, during a conversion between a target video block of a video and a bitstream of the video, a difference between a first motion vector prediction (MVP) candidate in at least one group of MVP candidates of the target video block and a second MVP candidate of the target video block; updating the at least one group based on a comparison between the difference and a threshold; and performing the conversion at least in part based on the updated at least one group.

Clause 38. The method of clause 37, wherein updating the at least one group comprises: in accordance with a determination that the difference is less than the threshold, removing at least one of the first MVP candidate or the second MVP candidate from the at least one group.

Clause 39. The method of clause 38, wherein performing the conversion at least in part based on the updated at least one group comprises: sorting the updated at least one group based on respective matching template costs of MVP candidates in the updated at least one group; determining an MVP candidate list based on the sorting; and performing the conversion based on the MVP candidate list.

Clause 40. The method of clause 37, further comprising: sorting a third MVP candidate and a fourth MVP candidate of the target video block without comparing a further difference between the third and fourth MVP candidates and the threshold; determining an MVP candidate list based on the sorting; and performing the conversion based on the MVP candidate list.

Clause 41. The method of clause 40, wherein the third MVP candidate belongs to a first group of the at least one group, and the fourth MVP candidate belongs to a second group of the at least one group, the second group being different from the first group.

Clause 42. The method of clause 40, wherein the third MVP candidate belongs to a first group of MVP candidates, and the fourth MVP candidate is absent from the at least one group.

Clause 43. The method of clause 37, wherein the at least one group of MVP candidates comprises a plurality of groups of MVP candidates sorted based on respective template matching costs of the MVP candidates.

Clause 44. The method of clause 37, wherein the at least one group comprises a plurality of groups of MVP candidates, and wherein performing the conversion at least in part based on the updated at least one group comprises: sorting at least one of the updated plurality of groups based on respective matching template costs of MVP candidates in at least one of the updated plurality of groups; determining an MVP candidate list based on the sorting; and performing the conversion based on the MVP candidate list.

Clause 45. The method of clause 43, wherein the first MVP candidate belongs to a first group of the at least one group, and the second MVP candidate belongs to a second group of the at least one group, the second group being different from the first group.

Clause 46. The method of clause 43, wherein the first MVP candidate belongs to a first group of MVP candidates, and the second MVP candidate is absent from the at least one group.

Clause 47. The method of clause 37, wherein the at least one group comprises a plurality of groups of MVP candidates, and wherein performing the conversion at least in part based on the updated at least one group comprises: determining an MVP candidate list based on the updated at least one group; sorting at least one group of candidates in the MVP candidate list; updating the MVP candidate list based on the sorting; and performing the conversion based on the updated MVP candidate list.

Clause 48. The method of clause 37, wherein the at least one group of MVP candidates comprises at least one of the following: a single group of MVP candidates, the single group being associated with a candidate category, or a joint group of MVP candidates, the joint group being associated with more than one candidate category.

Clause 49. The method of clause 48, wherein the candidate category comprises at least one of the following: an adjacent neighboring MVP category, an adjacent neighboring MVP at a predefined location, a temporal motion vector prediction (TMVP) MVP category, a history-based motion vector predictor (HMVP) MVP category, a non-adjacent MVP category, a constructed MVP category, a pairwise MVP category, an inherited affine MV candidate category, a constructed affine MV candidate category, or a subblock-based temporal motion vector prediction (SbTMVP) candidate category.

Clause 50. A method for video processing, comprising: determining, during a conversion between a target video block of a video and a bitstream of the video, respective template matching costs of a plurality of motion vector prediction (MVP) candidates of the target video block; determining an MVP candidate list by sorting the plurality of MVP candidates based on the respective template matching costs; performing an adaptive reordering merge candidates (ARMC) process on the MVP candidate list; and performing the conversion based on the performing of the ARMC process.

Clause 51. The method of clause 50, wherein performing the ARMC process comprises: performing the ARMC process based on the respective template matching costs of MVP candidates in the MVP candidate list.

Clause 52. The method of clause 50, wherein performing the ARMC process comprises: determining respective further template matching costs of MVP candidates in the MVP candidate list; and performing the ARMC process based on the respective further template matching costs of MVP candidates in the MVP candidate list.

Clause 53. The method of clause 52, wherein determining the respective further template matching costs comprises: determining the respective further template matching costs based on a further template different from a template used in the determination of the respective template matching costs.

Clause 54. A method for video processing, comprising: determining, during a conversion between a target video block of a video and a bitstream of the video, information regarding sorting of a plurality of motion vector prediction (MVP) candidates of the target video block based on a coding tool of the target video block; and performing the conversion based on the information.

Clause 55. The method of clause 54, wherein the information comprises at least one of the following: whether to enable the sorting of the plurality of MVP candidates, or how to enable the sorting of the plurality of MVP candidates.

Clause 56. The method of clause 54 or clause 55, wherein if the coding tool comprises a merge mode with motion vector difference (MMVD) coding tool or an affine mode coding tool, the information indicates to disable the sorting.

Clause 57. The method of any of clauses 54-56, wherein a first sorting rule associated with a first coding tool is different from a second sorting rule associated with a second coding tool.

Clause 58. The method of clause 57, wherein the first sorting rule is applied to a first group of MVP candidates, and the second sorting rule is applied to a second group of MVP candidates.

Clause 59. The method of clause 57, wherein the first sorting rule is applied to MVP candidates with a first template setting, and the second sorting rule is applied to MVP candidates with a second template setting.

Clause 60. The method of any of clauses 1-59, wherein the conversion includes encoding the target video block into the bitstream.

Clause 61. The method of any of clauses 1-59, wherein the conversion includes decoding the target video block from the bitstream.

Clause 62. An apparatus for processing video data comprising a processor and a non-transitory memory with instructions thereon, wherein the instructions upon execution by the processor, cause the processor to perform a method in accordance with any of clauses 1-61.

Clause 63. A non-transitory computer-readable storage medium storing instructions that cause a processor to perform a method in accordance with any of clauses 1-61.

Clause 64. A non-transitory computer-readable recording medium storing a bitstream of a video which is generated by a method performed by a video processing apparatus, wherein the method comprises: determining at least one group of motion vector predictions (MVP) candidates of a target video block of the video; determining an MVP candidate list by sorting the at least one group of MVP candidates based on respective template matching costs of MVP candidates in the at least one group; and generating the bitstream based on the MVP candidate list.

Clause 65. A method for storing a bitstream of a video, comprising: determining at least one group of motion vector predictions (MVP) candidates of a target video block of the video; determining an MVP candidate list by sorting the at least one group of MVP candidates based on respective template matching costs of MVP candidates in the at least one group; generating the bitstream based on the MVP candidate list; and storing the bitstream in a non-transitory computer-readable recording medium.

Clause 66. A non-transitory computer-readable recording medium storing a bitstream of a video which is generated by a method performed by a video processing apparatus, wherein the method comprises: determining respective template matching costs of a plurality of block vector candidates of a target video block of the video; determining a block vector candidate list based on the respective template matching costs; and generating the bitstream based on the block vector candidate list.

Clause 67. A method for storing a bitstream of a video, comprising: determining respective template matching costs of a plurality of block vector candidates of a target video block of the video; determining a block vector candidate list based on the respective template matching costs; generating the bitstream based on the block vector candidate list; and storing the bitstream in a non-transitory computer-readable recording medium.

Clause 68. A non-transitory computer-readable recording medium storing a bitstream of a video which is generated by a method performed by a video processing apparatus, wherein the method comprises: determining a difference between a first motion vector prediction (MVP) candidate in at least one group of MVP candidates of a target video block of the video and a second MVP candidate of the target video block; updating the at least one group based on a comparison between the difference and a threshold; and generating the bitstream at least in part based on the updated at least one group.

Clause 69. A method for storing a bitstream of a video, comprising: determining a difference between a first motion vector prediction (MVP) candidate in at least one group of MVP candidates of a target video block of the video and a second MVP candidate of the target video block; updating the at least one group based on a comparison between the difference and a threshold; generating the bitstream at least in part based on the updated at least one group; and storing the bitstream in a non-transitory computer-readable recording medium.

Clause 70. A non-transitory computer-readable recording medium storing a bitstream of a video which is generated by a method performed by a video processing apparatus, wherein the method comprises: determining respective template matching costs of a plurality of motion vector prediction (MVP) candidates of a target video block of the video; determining an MVP candidate list by sorting the plurality of MVP candidates based on the respective template matching costs; performing an adaptive reordering merge candidates (ARMC) process on the MVP candidate list; and generating the bitstream based on the performing of the ARMC process.

Clause 71. A method for storing a bitstream of a video, comprising: determining respective template matching costs of a plurality of motion vector prediction (MVP) candidates of a target video block of the video; determining an MVP candidate list by sorting the plurality of MVP candidates based on the respective template matching costs; performing an adaptive reordering merge candidates (ARMC) process on the MVP candidate list; generating the bitstream based on the performing of the ARMC process; and storing the bitstream in a non-transitory computer-readable recording medium.

Clause 72. A non-transitory computer-readable recording medium storing a bitstream of a video which is generated by a method performed by a video processing apparatus, wherein the method comprises: determining information regarding sorting of a plurality of motion vector prediction (MVP) candidates of a target video block of the video based on a coding tool of the target video block; and generating the bitstream based on the information.

Clause 73. A method for storing a bitstream of a video, comprising: determining information regarding sorting of a plurality of motion vector prediction (MVP) candidates of a target video block of the video based on a coding tool of the target video block; generating the bitstream based on the information; and storing the bitstream in a non-transitory computer-readable recording medium.

### Example Device

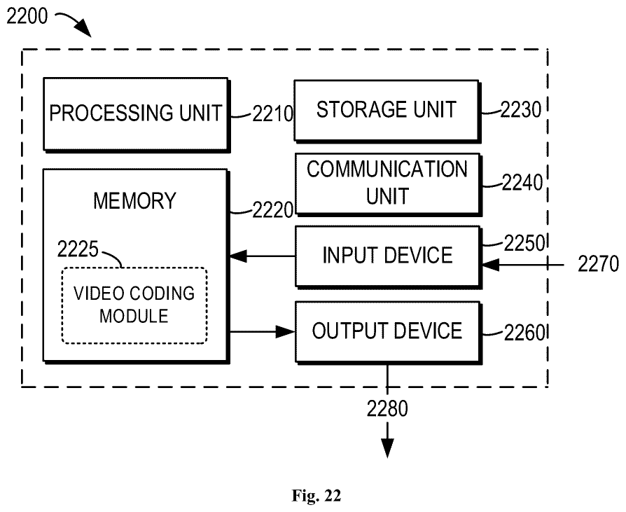

FIG. 22 illustrates a block diagram of a computing device 2200 in which various embodiments of the present disclosure can be implemented. The computing device 2200 may be implemented as or included in the source device 110 (or the video encoder 114 or 200) or the destination device 120 (or the video decoder 124 or 300).

It would be appreciated that the computing device 2200 shown in FIG. 22 is merely for purpose of illustration, without suggesting any limitation to the functions and scopes of the embodiments of the present disclosure in any manner.

As shown in FIG. 22, the computing device 2200 includes a general-purpose computing device 2200. The computing device 2200 may at least comprise one or more processors or processing units 2210, a memory 2220, a storage unit 2230, one or more communication units 2240, one or more input devices 2250, and one or more output devices 2260.

In some embodiments, the computing device 2200 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2200 can support any type of interface to a user (such as “wearable” circuitry and the like).

The processing unit 2210 may be a physical or virtual processor and can implement various processes based on programs stored in the memory 2220. In a multi-processor system, multiple processing units execute computer executable instructions in parallel so as to improve the parallel processing capability of the computing device 2200. The processing unit 2210 may also be referred to as a central processing unit (CPU), a microprocessor, a controller or a microcontroller.

The computing device 2200 typically includes various computer storage medium. Such medium can be any medium accessible by the computing device 2200, including, but not limited to, volatile and non-volatile medium, or detachable and non-detachable medium. The memory 2220 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2230 may be any detachable or non-detachable medium and may include a machine-readable medium such as a memory, flash memory drive, magnetic disk or another other media, which can be used for storing information and/or data and can be accessed in the computing device 2200.

The computing device 2200 may further include additional detachable/non-detachable, volatile/non-volatile memory medium. Although not shown in FIG. 22, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2240 communicates with a further computing device via the communication medium. In addition, the functions of the components in the computing device 2200 can be implemented by a single computing cluster or multiple computing machines that can communicate via communication connections. Therefore, the computing device 2200 can operate in a networked environment using a logical connection with one or more other servers, networked personal computers (PCs) or further general network nodes.

The input device 2250 may be one or more of a variety of input devices, such as a mouse, keyboard, tracking ball, voice-input device, and the like. The output device 2260 may be one or more of a variety of output devices, such as a display, loudspeaker, printer, and the like. By means of the communication unit 2240, the computing device 2200 can further communicate with one or more external devices (not shown) such as the storage devices and display device, with one or more devices enabling the user to interact with the computing device 2200, or any devices (such as a network card, a modem and the like) enabling the computing device 2200 to communicate with one or more other computing devices, if required. Such communication can be performed via input/output (I/O) interfaces (not shown).

In some embodiments, instead of being integrated in a single device, some or all components of the computing device 2200 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2200 may be used to implement video encoding/decoding in embodiments of the present disclosure. The memory 2220 may include one or more video coding modules 2225 having one or more program instructions. These modules are accessible and executable by the processing unit 2210 to perform the functionalities of the various embodiments described herein.

In the example embodiments of performing video encoding, the input device 2250 may receive video data as an input 2270 to be encoded. The video data may be processed, for example, by the video coding module 2225, to generate an encoded bitstream. The encoded bitstream may be provided via the output device 2260 as an output 2280.

In the example embodiments of performing video decoding, the input device 2250 may receive an encoded bitstream as the input 2270. The encoded bitstream may be processed, for example, by the video coding module 2225, to generate decoded video data. The decoded video data may be provided via the output device 2260 as the output 2280.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, during a conversion between a target video block of a video and a bitstream of the video, at least one group of motion vector predictions (MVP) candidates of the target video block;
determining an MVP candidate list by sorting the at least one group of MVP candidates based on respective template matching costs of MVP candidates in the at least one group; and
performing the conversion based on the MVP candidate list.

2. The method of claim 1, wherein the at least one group of MVP candidates comprises a first group of MVP candidates and a second group of MVP candidates, the first group being associated with one candidate category, the second group being associated with more than one category, or
wherein the second group comprises MVP candidates of at least first and second candidate categories, or
wherein the first candidate category comprises a non-adjacent MVP candidate category, and the second category comprises a history-based motion vector predictor (HMVP) candidate category, or
wherein the first group further comprises MVP candidates of a third candidate category different from the first and second candidate categories, or
wherein the third candidate category comprises a temporal motion vector prediction (TMVP) candidate category, or
wherein the first group comprises MVP candidates associated with a fourth candidate category, or
wherein the fourth candidate category comprises an adjacent MVP candidate category.

3. The method of claim 1, wherein the at least one group of MVP candidates comprises at least one single group of MVP candidates, the single group of MVP candidates being associated with a single candidate category, or
wherein the single candidate category comprises at least one of: an adjacent MVP candidate category, a non-adjacent MVP candidate category, or a history-based motion vector predictor (HMVP) candidate category.

4. The method of claim 1, wherein the at least one group of MVP candidates comprises at least one joint group of MVP candidates, the joint group of MVP candidates being associated with more than one candidate category.

5. The method of claim 4, wherein a joint group of the at least one joint group of MVP candidates comprises at least a partial of MVP candidates associated with more than one candidate category, or
wherein determining the at least one group comprises: in accordance with a determination that a coding tool of the target video block comprises a first coding tool, adding non-adjacent MVP candidates and history-based motion vector predictor (HMVP) candidates into a first joint group of MVP candidates, or
wherein the first coding tool comprises at least one of: a regular merge mode coding tool, a combination of intra and inter predication (CIIP) merge mode coding tool, a merge mode with motion vector difference (MMVD) coding tool, a geometric partitioning mode (GPM) coding tool, a triangle partition mode (TPM) coding tool, or a subblock merge mode coding tool, or
wherein determining the at least one group comprises: in accordance with a determination that a coding tool of the target video block comprises a second coding tool, adding adjacent MVP candidates, non-adjacent MVP candidates and history-based motion vector predictor (HMVP) candidates into a second joint group of MVP candidates, or
wherein the second coding tool comprises a template matching merge mode coding tool.

6. The method of claim 1, wherein the at least one group of MVP candidates comprises at least one single group of MVP candidates and at least one joint group of MVP candidates, the single group being associated with one candidate category, and the joint group being associated with more than one candidate category, or
wherein determining the at least one group comprises: dividing a plurality of MVP candidates of a same candidate category into a plurality of groups, or
wherein sorting the at least one group of MVP candidates comprises: for a group of the plurality of groups, sorting MVP candidates in the group based on respective template matching costs of the MVP candidates, or
wherein determining the at least one group comprises: adding a partial of MVP candidates of a fifth candidate category into a group of candidates, the group being associated with at least one candidate category comprising the fifth candidate category, or
wherein sorting the at least one group of MVP candidates comprises: sorting the at least one group of MVP candidates without sorting remaining candidates of the fifth candidate category.

7. The method of claim 4, wherein the candidate category comprises at least one of the following: an adjacent neighboring MVP category, an adjacent neighboring MVP at a predefined location, a temporal motion vector prediction (TMVP) MVP category, a history-based motion vector predictor (HMVP) MVP category, a non-adjacent MVP category, a constructed MVP category, a pairwise MVP category, an inherited affine MV candidate category, a constructed affine MV candidate category, or a subblock-based temporal motion vector prediction (SbTMVP) candidate category,
wherein determining the MVP candidate list comprises:
determining a set of MVP candidates from the at least one group of MVP candidates list based on a sorting result of the respective template matching costs; and
adding the set of MVP candidates into the MVP candidate list.

8. The method of claim 1, wherein determining the MVP candidate list comprises:
determining whether to add a first MVP candidate in the at least one group of MVP candidates into the MVP candidate list based on a sorting result of the respective template matching costs; and
determining the MVP candidate list based on the determination of adding the first MVP candidate.

9. The method of claim 1, wherein determining the MVP candidate list comprises:
determining a number of MVP candidates in the at least one group of MVP candidates to be added into the MVP candidate list based on a sorting result of the respective template matching costs; and
adding the number of MVP candidates from the at least one group of MVP candidates into the MVP candidate list.

10. The method of claim 1, wherein determining the MVP candidate list comprises:
adding a second MVP candidate in the at least one group with a smallest template matching cost into the MVP candidate list.

11. The method of claim 1, wherein determining the MVP candidate list comprises:
adding a second number of top MVP candidates in the at least one group in an ascending order of template matching costs into the MVP candidate list.

12. The method of claim 11, wherein the second number is a maximum allowed number of MVP candidates in the at least one group to be added into the MVP candidate list, or
wherein the second number comprises a predefined constant associated with the at least one group.

13. The method of claim 11, further comprising:
determining the second number based on template matching costs of MVP candidates in the at least one group.

14. The method of claim 11, further comprising:
including the second number in the bitstream.

15. The method of claim 11, wherein a value of the second number is associated with a first group of MVP candidates and a second group of MVP candidates.

16. The method of claim 11, wherein a first value of the second number associated with a first group of MVP candidates is different from a second value of the second number associated with a second group of MVP candidates.

17. The method of claim 1, wherein the conversion includes encoding the target video block into the bitstream, or
wherein the conversion includes decoding the target video block from the bitstream.

18. An apparatus for processing video data comprising a processor and a non-transitory memory with instructions thereon, wherein the instructions upon execution by the processor, cause the processor to perform acts comprising:
determining, during a conversion between a target video block of a video and a bitstream of the video, at least one group of motion vector predictions (MVP) candidates of the target video block;
determining an MVP candidate list by sorting the at least one group of MVP candidates based on respective template matching costs of MVP candidates in the at least one group; and
performing the conversion based on the MVP candidate list.

19. A non-transitory computer-readable storage medium storing instructions that cause a processor to perform acts comprising:
determining, during a conversion between a target video block of a video and a bitstream of the video, at least one group of motion vector predictions (MVP) candidates of the target video block;
determining an MVP candidate list by sorting the at least one group of MVP candidates based on respective template matching costs of MVP candidates in the at least one group; and
performing the conversion based on the MVP candidate list.

20. A non-transitory computer-readable recording medium storing a bitstream of a video which is generated by a method performed by a video processing apparatus, wherein the method comprises:
determining at least one group of motion vector predictions (MVP) candidates of a target video block of the video;
determining an MVP candidate list by sorting the at least one group of MVP candidates based on respective template matching costs of MVP candidates in the at least one group; and
generating the bitstream based on the MVP candidate list.
